(19) United States
(12) Patent Application Publication
(10) Pub. No.: US 2017/0258268 A1
(43) Pub. Date: Sep. 14, 2017

(54) THERMALLY SPRAYED RESISTIVE HEATERS AND USES THEREOF

(71) Applicants: THERMOCERAMIX INC., Boston, MA (US); REGAL WARE, INC., Kewaskum, WI (US)

(72) Inventors: Athinodoros Chris KAZANAS, Laval (CA); Pierre MARCOUX, Beloeil (CA); Richard C. ABBOTT, New Boston, NH (US)

(21) Appl. No.: 15/529,861

(22) PCT Filed: Nov. 25, 2015
(86) PCT No.: PCT/IB2015/059126

§ 371 Date: May 25, 2017

Related U.S. Application Data
(60) Provisional application No. 62/085,223, filed on Nov. 26, 2014.
(60) Provisional application No. 62/085,224, filed on Nov. 26, 2014.
(60) Provisional application No. 62/085,225, filed on Nov. 26, 2014.

(51) Int. Cl. A47J 37/06; C23C 4/10; H05B 3/00; B64D 15/12; H05B 3/14; H05B 3/26; H05B 3/68; C23C 4/073; H05B 3/08

(52) U.S. Cl. CPC A47J 37/0676; C23C 4/073; C23C 4/10; H05B 3/0095; H05B 3/08; H05B 3/141; H05B 3/265; H05B 3/68; B64D 15/12; H05B 2203/013; H05B 2203/017; H05B 2203/019

(57) ABSTRACT

A heater is provided having at least one thermally sprayed resistive heating layer, the resistive heating layer comprising a first metallic component that is electrically conductive and capable of reacting with a gas to form one or more carbide, oxide, nitride, and boride derivative; one or more oxide, nitride, carbide, and boride derivative of the first metallic component that is electrically insulating; and a third component capable of stabilizing the resistivity of the resistive heating layer. In some embodiments, the third component is capable of pinning the grain boundaries of the first metallic component deposited in the resistive heating layer and/or altering the structure of aluminum oxide grains deposited in the resistive heating layer.

### RELATED APPLICATIONS

This application claims priority to U.S. Provisional Application No. 62/085,225, filed Nov. 26, 2014; U.S. Provisional Application No. 62/085,224, filed Nov. 26, 2014; and U.S. Provisional Application No. 62/085,223, filed Nov. 26, 2014; the entire contents of which are hereby incorporated by reference.

### FIELD OF THE INVENTION

The present invention relates to the field of thermally sprayed resistive heaters, to methods for making resistive heaters, and to applications thereof.

### BACKGROUND OF THE INVENTION

Thermal spray technology has been used to deposit a coating for use as a heater. [symbol] resistive heater produces heat by the excitation of electrons within the atoms of the heater material. The rate at which heat is generated is the power, which depends on the amount of current flowing and the resistance to the current flow offered by the material. The resistance of a heater depends on a material property termed “resistivity,” and a geometric factor describing the length of the current path and the cross-sectional area through which the current must pass.

Thermally-sprayed coatings have a unique microstructure. During the deposition process, each particle enters the gas stream, melts, and cools to the solid form independent of other particles. When molten particles impact the substrate being coated, they impact (“splat”) as flattened circular platelets and freeze at high cooling rates. The coating is built up on the substrate by traversing the plasma gun apparatus repeatedly over the substrate, building up layer by layer until the desired thickness of coating has been achieved. Because the particles solidify as splats, the resultant microstructure is very lamellar with the grains approximating circular platelets randomly stacked above the plane of the substrate.

Resistive coatings have been deposited previously using thermal spray. In one such example, metal alloys such as 80% Nickel-20% Chrome are deposited and used as heaters. In another example, a metal alloy in powder form is mixed with powders of electrical insulators such as aluminum oxide prior to deposition. The blended material is then deposited using thermal spray to form a coating of resistive material. When nickel-chrome is deposited as a resistive heater, however, the bulk resistivity of the layer is still rather low, so that high resistance in a heating element cannot be achieved without a small cross-section and/or a long path length. When oxide-metal blends are deposited, large discontinuities in the composition of resistive layer, which produce variations in power distribution over a substrate, are frequently present.

In another example, resistive heaters including a metallic component that is electrically conductive (i.e., has low resistivity) and an oxide, nitride, carbide and/or boride derivative of the metallic component that is electrically insulating (i.e., has high resistivity) have been described (see, for example, U.S. Pat. No. 6,919,543). Resistivity is controlled in part by controlling the amount of oxide, nitride, carbide, and boride formation during the deposition of the metallic component and the derivative using a thermal spray process. Systems and methods [symbol] r heating materials using such resistive heater layers have also been described (see, for [symbol] example, U.S. Pat. No. 6,924,468), as well as various applications thereof (such as an electric [symbol] ill incorporating a resistive heater layer, as described in U.S. Pat. No. 7,834,296). However, [symbol] resistive heating layers can be unstable during heating, leading to uneven heating, reduced [symbol] eater life, and/or eventual heater failure.

Thus, a heretofore unaddressed need exists in the industry to address the aforementioned deficiencies and inadequacies.

### SUMMARY OF THE INVENTION

The present invention provides an electrically resistive heater and uses thereof. The resistive heater includes at least one thermally sprayed resistive heating layer, the heating layer including: a first metallic component that is electrically conductive (i.e., has low resistivity); one or more oxide, nitride, carbide, and boride derivative of the first metallic component that is electrically insulating (i.e., has high resistivity); and a third component that stabilizes the resistivity of the heating layer (e.g., has a negative temperature coefficient of resistivity (NTC)). Resistivity is controlled in part by controlling the amount of oxide, nitride, carbide, and/or boride formation during the deposition of the first metallic component and its derivative. The third component stabilizes the resistivity of the heater or heating layer during heating, thereby providing greater stability and/or longevity. The resistive heater has numerous industrial and commercial applications such as production of electric grills, molded thermoplastic parts, paper, and semiconductor wafers.

Accordingly, in a first aspect of the invention, there is provided an electrically resistive heater that includes a thermally sprayed resistive heating layer having a stable resistivity (e.g., the resistivity does not increase substantially during heating, or may increase by about 0.003% per ° C. or less during heating). The resistive heating layer has a resistivity of from about 0.0001 to about 1.0 Ω·cm. Application of current from a power supply to the resistive heating layer results in production of heat. Desirably, the heater is disposed on a substrate such as a grill or cooking surface or element.

In particular embodiments, more than one metal or metalloid is included in the first metallic component. For example, in such embodiments the first metallic component may include one or more metal or metalloid such as aluminum (Al), chromium (Cr), cobalt (Co), iron (Fe), and nickel (Ni).

In a particular embodiment, the third component is capable of pinning the grain boundaries of the first metallic component deposited in the resistive heating layer. The grain boundaries of the first metallic component may be pinned by the third component, inhibiting [symbol] ain growth or further grain growth during heating and thereby providing greater stability and/or longevity to the resistive heating layer. Accordingly, in some embodiments, there is provided an electrically resistive heater that includes a thermally sprayed resistive heating layer having stable metallic grains of the first metallic component(s) in the resistive heating layer.

In another embodiment, the first metallic component includes at least aluminum; the one or more oxide, nitride, carbide, and boride derivative of the first metallic component includes at least an aluminum oxide; and the third component is capable of altering the structure of aluminum oxide grains deposited in the resistive heating layer. In such embodiments, the aluminum oxide grain structure is altered by the third component, resulting in columnar aluminum oxide grains that can increase oxidation resistance or prevent further oxidation of the first metallic component in the resistive heating layer. Accordingly, in some embodiments there is provided an electrically resistive heater that includes a thermally sprayed resistive heating layer having columnar aluminum oxide grains that increase oxidation resistance or prevent further oxidation of the first metallic component(s) in the resistive heating layer. In such embodiments, the first metallic component may include for example aluminum and one or more additional metal or metalloid such as chromium (Cr), cobalt (Co), iron (Fe), and nickel (Ni).

In a second aspect of the invention, there is provided a thermally sprayed resistive heating layer on a substrate. The thermally sprayed resistive heating layer is formed by thermally spraying a feedstock in the presence of a gas that includes one or more of oxygen, nitrogen, carbon, and boron. The feedstock comprises a mixture of components M₁ and X, or an alloy or mixture having the structure of formula I:

M₁X (I).

M₁ is a first metallic component that is electrically conductive and capable of reacting with the gas (e.g., during thermal spraying) to form one or more carbide, oxide, nitride, and boride derivative. X is a third component and/or an elemental form of the third component (i.e., a material that reacts with the gas during thermal spraying to form the third component), the third component stabilizing the resistivity of the deposited resistive heating layer (e.g., during [symbol] ating). For example, in an embodiment, the third component has a negative temperature [symbol] coefficient of resistivity (NTC) and thereby stabilizes the resistivity of the resistive heating layer. [symbol] an embodiment, the third component stabilizes the resistivity such that the resistivity does not [symbol] increase substantially during heating. In another embodiment, resistivity increases by about [symbol] 003% per ° C. or less during heating.

In some embodiments, the third component is capable of pinning the grain boundaries of the first metallic component deposited in the resistive heating layer.

In one embodiment, M₁ comprises CrAl. In another embodiment, M₁ comprises AlSi. In another embodiment, M₁ comprises NiCrAl. In another embodiment, M₁ comprises CoCrAl. In another embodiment, M₁ comprises FeCrAl. In another embodiment, M₁ comprises FeNiAl. In another embodiment, M₁ comprises FeNiAlMo. In another embodiment, M₁ comprises FeNiCrAl. In another embodiment, M₁ comprises NiCoCrAl. In another embodiment, M₁ comprises CoNiCrAl. In another embodiment, M₁ comprises NiCrAlCo. In another embodiment, M₁ comprises NiCoCrAlHfSi. In another embodiment, M₁ comprises NiCoCrAlTa. In another embodiment, M₁ comprises NiCrAlMo. In another embodiment, M₁ comprises NiMoAl. In another embodiment, M₁ comprises NiCrAlMoFe. In another embodiment, M₁ comprises NiCrBSi. In another embodiment, M₁ comprises CoCrWSi. In another embodiment, M₁ comprises CoCrNiWTaC. In another embodiment, M₁ comprises CoCrNiWC. In another embodiment, M₁ comprises CoMoCrSi.

In one embodiment, X comprises aluminum. In another embodiment, X comprises barium. In another embodiment, X comprises bismuth. In another embodiment, X comprises boron. In another embodiment, X comprises carbon. In another embodiment, X comprises gallium. In another embodiment, X comprises germanium. In another embodiment, X comprises hafnium. In another embodiment, X comprises magnesium. In another embodiment, X comprises samarium. In another embodiment, X comprises silicon. In another embodiment, X comprises strontium. In another embodiment, X comprises tellurium. In another embodiment, X comprises yttrium. In another embodiment, X comprises boron phosphide. In another embodiment, X comprises barium titanate. In another embodiment, X comprises hafnium carbide. In another embodiment, X comprises silicon carbide. In another embodiment, X comprises boron nitride. In another embodiment, X comprises yttrium oxide.

In one embodiment, the alloy or mixture having the structure of formula I [symbol] comprises CrAlY. In another embodiment, the alloy or mixture having the structure of formula I comprises CoCrAlY. In another embodiment, the alloy or mixture having the structure of formula I comprises NiCrAlY. In another embodiment, the alloy or mixture having the structure [symbol] of formula I comprises NiCoCrAlY. In another embodiment, the alloy or mixture having the [symbol] structure of formula I comprises CoNiCrAlY. In another embodiment, the alloy or mixture having the structure of formula I comprises NiCrAlCoY. In another embodiment, the alloy or mixture having the structure of formula I comprises FeCrAlY. In another embodiment, the alloy or mixture having the structure of formula I comprises FeNiAlY. In another embodiment, the alloy or mixture having the structure of formula I comprises FeNiCrAlY. In another embodiment, the alloy or mixture having the structure of formula I comprises NiMoAlY. In another embodiment, the alloy or mixture having the structure of formula I comprises NiCrAlMoY. In another embodiment, the alloy or mixture having the structure of formula I comprises NiCrAlMoFeY.

In a particular embodiment, the feedstock comprises a mixture of components M₁, Al, and X, or an alloy or mixture having the structure of formula Ia:

M₁AlX (Ia)

where M₁ is a first metallic component that is electrically conductive and capable of reacting with the gas (e.g., during thermal spraying) to form one or more carbide, oxide, nitride, and boride derivative. Aluminum (Al) also reacts with the gas during the thermal spraying to form one or more carbide, oxide, nitride, and boride derivative thereof. In such embodiments, X may be a third component capable of altering the grain structure of the one or more aluminum derivative deposited in the resistive heating layer. In particular embodiments, the gas includes oxygen, and an aluminum oxide such as Al₂O₃ is deposited in the resistive heating layer, the grain structure of the aluminum oxide being altered desirably by X in the resistive heating layer, e.g., resulting in columnar aluminum oxide grains. In such embodiments, the gas may further comprise one or more of hydrogen, helium, and argon.

Further, in some embodiments, the resistive heating layer has a microstructure that resembles a plurality of flattened discs or platelets having an outer region of nitride, oxide, carbide, and/or boride derivatives of the aluminum and optionally of the first metallic [symbol] component, and an inner region of the first metallic component, where the nitride, oxide, carbide, and/or boride derivative of the aluminum in the outer region is deposited in grains that are columnar in shape and can thus increase oxidation resistance or prevent oxidation of the first metallic component(s) in the inner region, resulting in more even heating and/or longer heater [symbol] e, compared to resistive heating layers having an amorphous aluminum oxide structure in the [symbol] sence of the third component.

For simplicity, where “X” in the feedstock is referred to as the third component, it should be understood that X in the feedstock is intended to encompass both the third component and/or the elemental form of the third component. For example, in the case where yttrium oxide is the third component stabilizing the resistivity of the resistive heating layer, “X” in the feedstock may include yttrium oxide, yttrium (the elemental form of the third component), or a mixture thereof. In other words, the feedstock may contain the third component itself (in this example, yttrium oxide) and/or the feedstock may contain the elemental form (in this example, yttrium) of the third component, the third component (in this example, yttrium oxide) then being formed by reaction with the gas during the spraying process.

In another example, in the case where titanium nitride (TiN) is the third component and pins the grain boundaries of the first metallic component in the resistive heating layer, “X” in the feedstock may include titanium nitride, titanium (elemental form of the third component), or a mixture thereof. In other words, the feedstock may contain the third component itself (in this example, titanium nitride) or the feedstock may contain the elemental form (in this example, titanium) of the third component, the third component (in this example, titanium nitride) being formed by reaction with the gas during the spraying process.

In a particular embodiment, the gas includes oxygen and M₁ includes aluminum such that an aluminum oxide such as Al₂O₃ is deposited in the resistive heating layer, along with the free metallic component(s) and the third component.

In some embodiments, the gas further comprises one or more of hydrogen, helium, and argon.

In particular embodiments, the third component may include one or more ceramic or semiconductor material or rare-earth element. For example, the third component may include, without limitation, one or more of aluminum, barium, bismuth, boron, carbon, gallium, germanium, hafnium, magnesium, samarium, silicon, strontium, tellurium, and yttrium; or a [symbol] :ride, oxide, carbide, nitride, or carbo-nitride derivative thereof; or a mixture or alloy thereof. [symbol] some embodiments, the third component may include, without limitation, boron phosphide, [symbol] rium titanate, hafnium carbide, silicon carbide, boron nitride, or yttrium oxide.

It is well-known that for most materials including metals, electrical resistivity increases with increasing temperature, decreasing the electrical conductivity of the material. In contrast, for materials with a negative temperature coefficient of resistivity (NTC), electrical resistivity decreases (and electrical conductivity increases) with increasing temperature. The present invention is based, at least in part, on the inventors' finding that uneven increases in the resistivity during heating of the resistive heating layer can weaken the heating layer, resulting for example in uneven heating and/or heater failure. Without wishing to be limited by theory, it is believed that, due at least in part to the non-homogeneous microstructure of thermally-sprayed coatings (as described above, and depicted in FIG. 1), uneven changes in resistivity during heating can lead to localized hotspots; such hotspots are also subject to higher oxidation rates, further degrading the integrity of the heating layer, and potentially leading to a vicious cycle of hotter spots, followed by more oxidation, etc. The inventors found that these effects can be alleviated by the presence of a third component that stabilizes the resistivity, effectively flattening the temperature coefficient of resistivity (TCR) of the resistive heating layer and thus minimizing deleterious, uneven increases in resistivity that are harmful to the desired mechanical, electrical, and/or thermal properties of the resistive heating layer. Further, the inventors have found that the presence of a material having an NTC can act to stabilize desirably the resistivity of the resistive heater or heating layer.

In one embodiment, the resistive heating layer has a microstructure that resembles a plurality of flattened discs or platelets having an outer region of nitride, oxide, carbide, and/or boride derivative(s) of the first metallic component(s) and an inner region of the first metallic component(s), with the third component dispersed in the resistive heating layer. The third component results in more even heating, reduced heater failure, and/or longer heater life, compared to resistive heating layers that lack the third component and are prone to increases in resistivity during heating.

It is well-known that polycrystalline materials are composed of grains and grain boundaries. The total volume of occupied grain boundaries depends on the grain size. When grain size increases, the volume fraction of grain boundaries decreases. Different properties (e.g., mechanical, electrical, optical, magnetic) of such materials are affected by the size of their grains [symbol] nd by the atomic structure of their grain boundaries. In some embodiments, the present invention is based, at least in part, on the inventors' finding that grain growth during heating of [symbol] resistive heating layer can weaken the heating layer (resulting, for example, in uneven heating and/or heater failure), and that this effect can be alleviated by the presence of a third component that acts to pin the grain boundaries, minimizing deleterious grain growth that is harmful to mechanical, electrical, and/or thermal properties of the resistive heating layer. In such embodiments, the third component may include one or more metal, metalloid, ceramic, or rare-earth element. For example, the third component may include one or more boride, oxide, carbide, nitride, and carbo-nitride derivative of boron (B), carbon (C), strontium (Sr), titanium (Ti), yttrium (Y), and zirconium (Zr), or a mixture or alloy thereof. Further, in such embodiments the resistive heating layer may have a microstructure that resembles a plurality of flattened discs or platelets having an outer region of nitride, oxide, carbide, and/or boride derivative(s) of the first metallic component(s) and an inner region of the first metallic component(s), with the third component dispersed at the grain boundaries of the first metallic component. Without wishing to be limited by theory, it is believed that the third component dispersed at the grain boundaries can result in more even heating, reduced heater failure, and/or longer heater life, compared to resistive heating layers that lack the third component and are prone to grain growth or slippage during heating.

In a third, related aspect, the invention features a method of producing a resistive heater having a substrate and a resistive heating layer having a stable resistivity (e.g., the resistivity does not increase substantially during heating, or may increase by about 0.003% per ° C. or less during heating). The method includes the steps of selecting a first metallic component that is electrically conductive and capable of reacting with a gas to form one or more carbide, oxide, nitride, and boride derivative; selecting a third component capable of stabilizing the resistivity of the resistive heating layer; and thermally spraying a mixture of the first metallic component and the third component (or an elemental form thereof) in the presence of the gas onto the substrate, so that the resistive heating layer is deposited on the substrate. Thermal spraying is performed under conditions where: at least a portion of the first metallic component reacts with the gas to form the one or more carbide, oxide, nitride, and boride derivative; the [symbol] emental form of the third component, if present, reacts at least partially with the gas to form the third component; and, the third component is dispersed in the resistive heating layer. The deposited resistive heating layer comprises the first metallic component, the one or more carbide, [symbol] dide, nitride, and boride derivative thereof, and the third component.

In some embodiments, the method includes the steps of selecting a third component capable of pinning the first metallic component's grain boundaries in the resistive heating layer. In such embodiments, thermal spraying may be performed under conditions where the third component is dispersed at the grain boundaries of the first metallic component in the resistive heating layer. Further, in such embodiments the third component may include one or more boride, oxide, carbide, nitride, carbo-nitride, or similar derivative of actinium (Ac), boron (B), carbon (C), hafnium (Hf), lanthanum (La), lutetium (Lu), molybdenum (Mo), niobium (Nb), palladium (Pd), rubidium (Rb), rhodium (Rh), ruthenium (Ru), scandium (Sc), strontium (Sr), tantalum (Ta), technetium (Tc), titanium (Ti), yttrium (Y), zirconium (Zr), or a mixture thereof. In some such embodiments, the third component includes a boride, oxide, carbide, or nitride derivative of boron (B), carbon (C), strontium (Sr), titanium (Ti), yttrium (Y), zirconium (Zr), or a mixture thereof. Exemplary third components in such embodiments include, without limitation, hafnium diboride, strontium oxide (SrO), strontium nitride (Sr₃N₂), tantalum diboride, titanium nitride (TiN), titanium carbide, titanium dioxide (TiO₂), titanium(II) oxide (TiO), titanium(III) oxide (Ti₂O₃), titanium diboride (TiB₂), yttria (also known as yttrium oxide (Y₂O₃)), yttrium nitride (YN), yttrium diboride (YB₂), yttrium carbide (YC₂), zirconium diboride, and mixtures thereof. In some such embodiments, the third component includes zirconium silicide (Zr₃Si).

In some embodiments, the first metallic component includes aluminum (Al); the gas includes oxygen and optionally one or more of nitrogen, carbon, and boron; and there is selected a third component capable of altering the structure of aluminum oxide grains deposited in the resistive heating layer; where a mixture of the first metallic component and the third component is thermally sprayed in the presence of the gas onto the substrate, so that the resistive heating layer is deposited on the substrate. In such embodiments, thermal spraying may be performed under conditions where: at least a portion of the first metallic component including aluminum reacts with the oxygen so that an aluminum oxide is formed; at least a portion of additional metallic component(s), if present, reacts with the gas to form the one or more carbide, [symbol] dide, nitride, and boride derivative; no more than a portion of the third component reacts with [symbol] Le gas (in other words, the third component reacts only partially with the gas); and the third component alters the structure of the aluminum oxide grains deposited in the resistive heating layer, e.g., resulting in columnar aluminum oxide grains. In such embodiments, the deposited resistive heating layer comprises the first metallic component, the one or more carbide, oxide, [symbol] tride, and boride derivative thereof including the aluminum oxide, and the third component. In some such embodiments, the third component may include actinium (Ac), cerium (Ce), lanthanum (La), lutetium (Lu), scandium (Sc), unbiunium (Ubu), yttrium (Y), or a mixture or alloy thereof. In one such embodiment, the third component is a rare-earth element. In a particular embodiment, the first metallic component and the aluminum are provided together in the form of a mixture or an alloy. For example, they may be provided as, without limitation, CrAl, AlSi, NiCrAl, CoCrAl, FeCrAl, FeNiAl, FeNiCrAl, FeNiAlMo, NiCoCrAl, CoNiCrAl, NiCrAlCo, NiCoCrAlHfSi, NiCoCrAlTa, NiCrAlMo, NiMoAl, or NiCrAlMoFe. In other such embodiments, the first metallic component, the aluminum, and the third component are provided together in the form of a mixture or an alloy, such as, without limitation, CrAlY, CoCrAlY, NiCrAlY, NiCoCrAlY, CoNiCrAlY, NiCrAlCoY, FeCrAlY, FeNiAlY, FeNiCrAlY, NiMoAlY, NiCrAlMoY, or NiCrAMoFeY. A mixture or alloy may be provided in various physical forms including, without limitation, wire, powder, and ingots. It is noted that, in the case of a powder, the mixture need not be pre-alloyed.

In various embodiments, thermal spraying may include arc spraying, plasma spraying, flame spraying, use of Rockide systems for spraying, arc wire spraying, and/or high velocity oxy-fuel (HVOF) thermal spraying, as well as other forms of thermal and cold spray.

In some embodiments, the first metallic component includes aluminum (Al), carbon (C), cobalt (Co), chromium (Cr), hafnium (Hf), iron (Fe), magnesium (Mg), manganese (Mn), molybdenum (Mo), nickel (Ni), silicon (Si), tantalum (Ta), titanium (Ti), tungsten (W), vanadium (V), zirconium (Zr), or a mixture or alloy thereof.

In some embodiments, the third component includes one or more of aluminum, barium, bismuth, boron, carbon, gallium, germanium, hafnium, magnesium, samarium, silicon, strontium, tellurium, and yttrium; one or more boride, oxide, carbide, nitride, or carbo-nitride derivative thereof; and/or a mixture or alloy thereof. In some embodiments, the third component includes boron phosphide, barium titanate, hafnium carbide, silicon carbide, boron nitride, and/or [symbol] trium oxide.

In particular embodiments, the first metallic component includes more than one metal or metalloid component that may be provided together in the form of a mixture or an alloy. for example, the first metallic component may include two or more metal or metalloid components provided as an alloy or mixture, such as, without limitation, CrAl, AlSi, NiCrAl, CoCrAl, FeCrAl, FeNiAl, FeNiCrAl, FeNiAlMo, NiCoCrAl, CoNiCrAl, NiCrAlCo, NiCrBSi, CoCrWSi, CoCrNiWTaC, CoCrNiWC, CoMoCrSi, NiCoCrAlHfSi, NiCoCrAlTa, NiCrAlMo, NiMoAl, or NiCrAlMoFe.

In other embodiments, the first metallic component(s) and the third component (or elemental form thereof) in the feedstock are provided together in the form of a mixture or an alloy, such as, without limitation, CrAlY, CoCrAlY, NiCrAlY, NiCoCrAlY, CoNiCrAlY, NiCrAlCoY, FeCrAlY, FeNiAlY, FeNiCrAlY, NiMoAlY, NiCrAlMoY, or NiCrAMoFeY.

A mixture or alloy in the feedstock may be provided in various physical forms including, without limitation, wire, powder, and ingots. It is noted that, in the case of powder, the mixture need not be pre-alloyed.

In a fourth, related aspect, the invention provides a system and method for heating materials. Briefly described, in architecture, one embodiment of the system, among others, can be implemented as follows: The system contains a first layer upon which a material may be placed for heating the material, wherein the first layer has sufficient conductivity to allow heat to travel through the first layer. The system also contains a heater layer provided on the first layer, which is capable of providing heat to the first layer for heating the material. In addition, the system has an insulator layer for protecting the heater layer from contaminants. In some embodiments, a heater layer or a resistive heating layer of the invention is thermally sprayed on a first layer, wherein the first layer is capable of supporting a material to be heated; and an insulator layer is fabricated on the heater layer (or the resistive heating layer), wherein the insulator layer protects the heater layer (or the resistive heating layer) from contaminants.

In a fifth, related aspect, the invention features an electric grill including a heater or a resistive heating layer of the invention. In one embodiment, the electric grill has a grate, an electrical insulator layer located on a bottom portion of the grate, a thermally-sprayed resistive heating layer deposited on a bottom portion of the electrical insulator layer, on a portion opposite [symbol] Le grate, and a heater plate located between the grate and the electrical insulator layer, where the heater plate is capable of receiving energy radiated from the heating layer and transferring the received energy to the grate.

In another embodiment, the electric grill has a grate, a first electrical insulator layer located above the grate, a heater layer deposited on a top surface of the first electrical insulator layer, and a top layer located over the heater layer for protecting the heater layer.

A resistive heating layer can also be provided, for example, on a heat shield, on a support tray for ceramic briquettes or the like, or on a heater panel suspended from the hood of the grill. In some embodiments, an electric grill comprises a shaped metal sheet, than can be formed by stamp pressing, for example, to provide a grill having a plurality of raised ridges.

In other aspects, methods for producing an electric grill including a resistive heating layer are provided, for example by depositing the resistive heating layer using thermal spray, such as arc spray, plasma spray, flame spray, arc wire spray, and/or high velocity oxy-fuel (HVOF) thermal spray, or any other form of thermal or cold spray.

In further aspects, there are provided other applications of the heaters and resistive heating layers of the invention. For example, in some embodiments the substrate is an injection mold, a roller, or a platen for semiconductor wafer processing. In an aspect, there is provided an injection mold that includes (i) a mold cavity surface and (ii) a coating that includes a resistive heater of the invention that in turn includes a resistive heating layer as described herein, the coating being present on at least a portion of the surface. In some embodiments, the mold includes a runner, and the coating is disposed on at least a portion of a surface of the runner.

In another aspect, there is provided a cylindrical roller including an outer surface, an inner surface surrounding a hollow core, and a resistive heater including a resistive heating layer of the invention coupled to a power source. In still another aspect, there is provided a method of drying paper during manufacturing. This method includes the steps of providing paper including a water content of greater than about 5% and one or more cylindrical rollers, as described above; heating the roller with a resistive heater of the invention; and contacting the paper with the roller for a time suitable for drying the paper to a water content of less than about 5%.

In yet another aspect, the invention features a semiconductor wafer processing system including an enclosure defining a reaction chamber; a support structure mounted within [symbol] the reaction chamber, the support structure mounting a semiconductor wafer to be processed within the chamber; and a resistive heater including a resistive heating layer of the invention coupled to a power source. In one embodiment, a heater is placed on the top of the reaction chamber such that one side (typically polished) of a wafer may be placed adjacent to or in contact with the heater. In another embodiment, a heater is placed on the bottom of the chamber such that one side (polished or unpolished) of a wafer may be placed adjacent to or in contact with the heater. In yet another embodiment, heaters are placed on the top and the bottom of the chamber.

In various embodiments of any of the foregoing aspects, the resistive heating layer has a resistivity of from about 0.0001 to about 1.0 Ω·cm (e.g., from about 0.0001 to about 0.001 Ω·cm, from about 0.001 to 0.01 Ω·cm, from about 0.01 to about 0.1 Ω·cm, from about 0.1 to about 1.0 Ω·cm, or from about 0.0005 to about 0.0020 Ω·cm). In some embodiments, the resistive heating layer is from about 0.002 to about 0.040 inches thick. In some embodiments, the average grain size of the first metallic component in the resistive heating layer is from about 10 to about 400 microns.

The application of current from a power supply to the resistive heating layer results in production of heat by the resistive heating layer. In various embodiments, the resistive heating layer is capable of generating a sustained temperature of greater than about 200° F., about 350° F., about 400° F., about 500° F., about 600° F., about 900° F., about 1200° F., about 1400° F., or about 2200° F. In a particular embodiment, the heater and/or the resistive heating layer operates at 120 volts. In another embodiment, the heater and/or the resistive heating layer operates at 220 volts.

In various other embodiments, the resistive heater includes an electrically insulating layer (e.g., a layer including aluminum oxide or silicon dioxide) between the substrate and the resistive heating layer; an adhesion layer (e.g., one including nickel-chrome alloy, nickel-chrome-aluminum-yttrium alloy, or nickel-aluminum alloy) between the insulating layer and the substrate; a heat reflective layer (e.g., a layer including zirconium oxide) between the resistive heating layer and the substrate; a ceramic layer (e.g., one including aluminum oxide) superficial to the resistive heating layer; and/or a metallic layer (e.g., one including molybdenum or tungsten) superficial to the resistive heating layer. In particular embodiments, insulating layers [symbol] positioned above or below the heater to insulate the resistive heating layer electrically from adjacent, electrically conductive components. Additional layers can be added to reflect or emit heat from the heater in a selected pattern. One or more layers can also be included to provide approved thermal matching between components to prevent bending or fracture of different layers having different coefficients of thermal expansion. Layers that improve the adhesion between layers and the substrate may also be used.

In some embodiments, the resistive heating layer is connected to a power supply.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

Other features and advantages of the present invention will be apparent from the following detailed description of the invention, taken in conjunction with the accompanying drawings. The components in the drawings are not necessarily to scale, emphasis instead being placed upon clearly illustrating the principles of the present invention. Moreover, in the drawings, like reference numerals designate corresponding parts throughout the several views.

FIG. 1 shows an illustration of deposited microstructure of one embodiment of a resistive heating layer of this invention;

FIG. 2 shows an illustration of an HVOF wire system 2 that uses metal wire 4 as feedstock and combustion of fuel gases 6 for melting the feedstock. A reactant gas 8 reacts with the molten feedstock and transports the molten droplets to a substrate 10 to produce a layer 12;

FIG. 3 shows an illustration of a plasma spray system 100 that uses metal powder 110 as feedstock and generates an argon 120/hydrogen 130 plasma to melt the powder. Another reactant gas 140 is supplied to the molten droplets through a nozzle 150. The molten droplets are deposited as a layer 160 on a substrate 170;

FIG. 4 is a schematic diagram illustrating an example of an electric grill, in accordance with one exemplary embodiment of the invention;

FIG. 5 is a schematic diagram illustrating an example of an electric grill, in accordance with one exemplary embodiment of the invention;

FIG. 6 is a schematic diagram further illustrating a grate located within the electric grill of FIG. 5;

FIG. 7 is a schematic diagram illustrating a variation of the electric grill of FIG. 4;

FIG. 8 is a schematic diagram illustrating an electric grill, in accordance with one exemplary embodiment of the invention;

FIG. 9 is a schematic diagram illustrating an electric grill, in accordance with one exemplary embodiment of the invention;

FIG. 10 is a schematic diagram illustrating an electric grill, in accordance with one embodiment of the present invention;

FIG. 11 is a cross-section view of the electric grill of FIG. 10 illustrating a plurality of ridges separated by open spaces;

FIG. 12 is a schematic diagram illustrating the underside of the electric grill of FIG. 10;

FIG. 13 is a schematic illustration of a method of providing an electric grill;

FIG. 14 is a schematic diagram illustrating an electric grill according to one embodiment of the present invention;

FIG. 15 is a schematic diagram illustrating an electric grill according to one embodiment of the present invention;

FIG. 16 is a schematic diagram illustrating an electric grill with an odor-removal device according to one embodiment of the present invention;

FIG. 17 is a schematic diagram illustrating an electric grill with an odor-removal device combined with a heat exchanger according to one embodiment of the present invention; and

FIG. 18 is a schematic diagram illustrating an electric grill with an odor-removal device combined with a heat exchanger and a re-circulator according to one embodiment of the present invention.

### DETAILED DESCRIPTION OF THE PREFERRED EMBODIMENTS

There is provided herein a heater comprising at least one thermally sprayed resistive heating layer (and methods of making same, and applications thereof) that includes a first metallic component that is electrically conductive and capable of reacting with a gas to form [symbol] e or more carbide, oxide, nitride, and boride derivative thereof; an oxide, nitride, carbide, and/or boride derivative of the metallic component that is electrically insulating; and a third component that is capable of stabilizing the resistivity of the resistive heating layer. The resistive heating layer functions as a heater when coupled to a power supply, as described for example in U.S. Pat. No. 6,919,543, the contents of which are hereby incorporated by reference in their entirety.

In some embodiments, the third component is capable of pinning the grain boundaries of the first metallic component deposited in the resistive heating layer.

In some embodiments, the first metallic component includes aluminum (Al); the oxide, nitride, carbide, and/or boride derivative of the metallic component includes an aluminum oxide; and the third component is capable of altering the structure of the aluminum oxide grains deposited in the resistive heating layer (e.g., resulting in columnar aluminum oxide grains).

In brief, to deposit a heating layer that will generate heat when a voltage is applied, the layer must have a resistance that is determined by the desired power level. The resistance, R, is calculated from the applied voltage, V, and the desired power level, P, from R=V²/P. The resistance is related to the geometry of the heater coating (the electric current path length, L, and the cross sectional area, A, through which the current passes) and the material resistivity (ρ) by the equation R=ρL/A_{cs}. Therefore, to design a heating layer for a given power level and a given geometry that will operate at a given voltage, one has only to determine the resistivity of the material by: ρ=R A_{cs}/L=V²A_{cs}/PL.

In the resistive heating layers provided herein, resistivity is controlled in part by controlling the amount of oxide, nitride, carbide, and/or boride formation during thermal spraying and deposition of the first metallic component and its derivative. That the resistivity is a controlled variable is significant because it represents an additional degree of freedom for a heater designer. However, in the absence of the third component, the resistivity of the heater or heating layer can increase unevenly when heated, leading to weakening of the resistive heating layer, uneven heating and/or eventual heater failure, potentially shortening the heater life.

In some embodiments, where the first metallic component comprises only aluminum, resistivity is controlled in part by controlling the amount of aluminum oxide formation during thermal spraying and deposition of the first metallic component and its [symbol] deposition.

[symbol] In some embodiments, in the absence of the third component, grains of the first metallic component can grow in size when heated, potentially leading to grain slippage, and weakening of the resistive heating layer. In some embodiments, in the absence of the third component, aluminum oxide forms as amorphous grains, typically approximating circular platelets randomly stacked above the plane of the substrate. Such resistive heating layers are also prone to uneven heating and/or eventual heater failure, potentially shortening the heater life.

The present invention is based, at least in part, on the inventors' finding that stabilizing the resistivity of the resistive heating layer provides a more stable resistive heating layer or heater, with the advantage of more even heating and/or longer heater life, compared to resistive heating layers in which the resistivity is not stabilized, and can increase unevenly during heating. In some embodiments, the present invention is based, at least in part, on the inventors' finding that pinning the grain boundaries of the first metallic component provides a more stable resistive heating layer with the advantage of more even heating and/or longer heater life, compared to resistive heating layers in which the grain boundaries are not pinned.

It is noted that aluminum oxide deposited with an amorphous grain structure provides little or no protection against oxidation of the first metallic component in the resistive heating layer. In this case, the first metallic component remains susceptible to oxidation or further oxidation during heating. In some embodiments therefore, the present invention is based, at least in part, on the inventors' finding that, in the presence of the third component, the structure of the aluminum oxide grains is altered. Specifically, aluminum oxide forms as columnar grains that are fairly uniform in shape and able to pack closely together. Without wishing to be limited by theory, it is believed that closely-packed, columnar aluminum oxide grains increase oxidation resistance and/or prevent oxidation of the underlying first metallic component in the resistive heating layer. This effect can provide for more even heating, more stability of the resistive heating layer, and/or longer heater life, compared to heating layers with amorphous aluminum oxide grains.

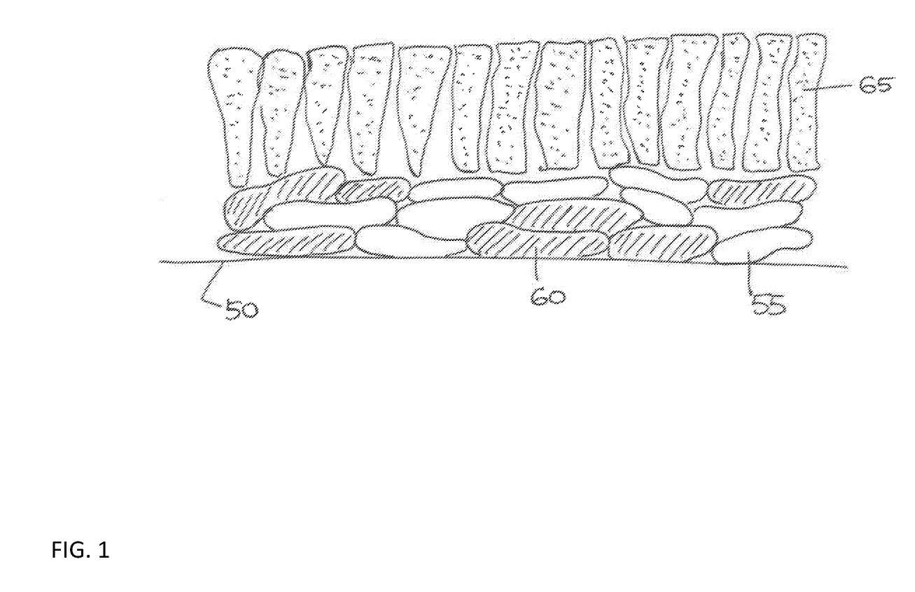

A schematic representation of the structure of the resistive heating layer of the invention formed in the presence of the third component is shown in FIG. 1. In FIG. 1, there is shown one illustrative embodiment of a resistive heating layer of the invention formed on substrate 50, depicting: aluminum oxide grains 65; first metallic component 55 (unshaded [symbol] materials) deposited in a layer with an oxide, nitride, carbide or boride derivative thereof 60 stippled materials); and third component 70 dispersed in the resistive heating layer. In one illustrative embodiment, the third component 70 is dispersed at the grain boundaries of first metallic component 55. FIG. 1 also shows a schematic representation of the aluminum oxide [symbol] grain structure formed in the presence of the third component, in one illustrative embodiment, [symbol] where columnar and closely packed aluminum oxide grains 65 inhibit oxidation or further oxidation of first metallic component 55 (unshaded materials) deposited in a layer with oxide, nitride, carbide or boride derivative thereof 60 (stippled materials).

We now describe the resistive heater layer, its application as a component of a coating, and its use as a resistive heater.

### First Metallic Components and Oxides, Nitrides, Carbides, and Borides Thereof

Metallic components for use as first metallic components of the invention include any metals or metalloids that are capable of reacting with a gas to form a carbide, oxide, nitride, boride, or combination thereof. Exemplary first metallic components include, without limitation, transition metals such as titanium (Ti), vanadium (V), cobalt (Co), nickel (Ni), iron (Fe), chromium (Cr), and transition metal alloys; highly reactive metals such as magnesium (Mg), zirconium (Zr), hafnium (Hf), and aluminum (Al); refractory metals such as tungsten (W), molybdenum (Mo), and tantalum (Ta); metal composites such as aluminum/aluminum oxide and cobalt/tungsten carbide; and metalloids such as silicon (Si). Metallic components may further comprise additional elements such as carbon (C).

A first metallic component may also be a mixture of two or more of these metals or metalloids. Exemplary mixtures include, without limitation, mixtures of iron and aluminum, nickel and aluminum, cobalt and aluminum, chromium and aluminum, and silicon and aluminum. Further exemplary mixtures include, without limitation, mixtures of iron, chromium, and aluminum; nickel, chromium, and aluminum; and cobalt, chromium, and aluminum. Two or more metals or metalloids may be mixed together during spraying or pre-mixed in a feedstock before spraying.

In some embodiments, a mixture of two or more metals is in the form of an alloy. Non-limiting examples of alloys for use as a first metallic component include CrAl, NiAl, CoCr, AlSi, NiCrAl, CoCrAl, FeCrAl, FeNiAl, FeNiCrAl, FeNiAlMo, NiCoCrAl, CoNiCrAl, NiCrAlCo, NiCoCrAlHfSi, NiCoCrAlTa, NiCrAlMo, NiCrBSi, NiMoAl, and NiCrAlMoFe. [symbol] other alloys are known by those skilled in the art. Alloys may be provided in various forms such [symbol] powder, wire, solid bar, ingot, etc. It should be understood that it is not required that a mixture of two or more metals be pre-alloyed, and in some embodiments, a mixture of two or more metals is not pre-alloyed.

First metallic components typically have a resistivity in the range of 1-100×10⁻⁸ [symbol] . During the coating process (e.g., thermal spraying), a feedstock (e.g., powder, wire, or solid bar) of the metallic component is melted to produce, e.g., droplets and exposed to a gas containing oxygen, nitrogen, carbon, and/or boron. This exposure allows the molten first metallic component to react with the gas to produce an oxide, nitride, carbide, or boride derivative, or combination thereof, on at least a portion of the surface of the droplet.

It should be understood that, when two or more metals are included in the first metallic component, one or more of the metals may form a derivative during the thermal spraying process. For example, in the presence of oxygen, aluminum is typically oxidized to form an aluminum oxide such as Al₂O₃; additional metallic components may also be oxidized. The nature of the reacted metallic component is dependent on the amount and nature of the gas used in the deposition. For example, use of pure oxygen results in an oxide of the metallic component, whereas a mixture of oxygen, nitrogen, and carbon dioxide results in a mixture of oxide, nitride, and carbide. The exact proportion of each depends on intrinsic properties of the metallic component and on the proportion of oxygen, nitrogen, and carbon in the gas. The resistivity of the layers produced by the methods herein varies and can range, for example, from about 500 to about 50,000×10⁻⁸ Ω·m, or from about 0.0001 to about 1.0 Ω·cm.

Exemplary species of oxide include, without limitation, TiO₂, TiO, ZrO₂, V₂O₅, V₂O₃, V₂O₄, CoO, Co₂O₃, CoO₂, Co₃O₄, NiO, MgO, HfO₂, Al₂O₃, Al₂O, AlO, WO₃, WO₂, MoO₃, MoO₂, Ta₂O₅, TaO₂, and SiO₂. Non-limiting examples of nitrides include TiN, VN, Ni₃N, Mg₃N₂, ZrN, AlN, and Si₃N₄. Desirable carbides include, for example, TiC, VC, MgC₂, Mg₂C₃, HfC, Al₄C₃, WC, Mo₂C, TaC, and SiC. Exemplary borides include TiB, TiB₂, VB₂, Ni₂B, Ni₃B, AlB₂, TaB, TaB₂, SiB, and ZrB₂. Other oxides, nitrides, carbides, and borides are known by those skilled in the art.

### Gases

In order to obtain oxides, nitrides, carbides, or borides of a metallic component, the gas that is reacted with the component must contain oxygen, nitrogen, carbon, and/or boron. [symbol] exemplary gases include oxygen, nitrogen, carbon dioxide, air, boron trichloride, ammonia, methane, and diborane. Other gases are known by those skilled in the art.

In some embodiments, a gas may further comprise one or more of hydrogen, [symbol] helium, and argon.

### Third Components

Third components of the invention include any materials that are capable of stabilizing the resistivity of the resistive heating layer. Typically, a third component is a ceramic, a semiconductor, or a rare-earth element, although other materials may be used. In general, any material that has a negative temperature coefficient of resistivity (NTC) can act to stabilize the resistivity during heating. Exemplary third components include, without limitation, one or more of aluminum, barium, bismuth, boron, carbon, gallium, germanium, hafnium, magnesium, samarium, silicon, strontium, tellurium, and yttrium; or a boride, oxide, carbide, nitride, or carbo-nitride derivative thereof; or a mixture or alloy thereof. In some embodiments, the third component may include, without limitation, one or more of boron phosphide, barium titanate, hafnium carbide, silicon carbide, boron nitride, and yttrium oxide.

A third component may be formed during the thermal spraying process from an elemental form thereof. For example, an elemental form of the third component may be sprayed, the elemental form reacting with the gas during spraying to form a boride, oxide, nitride, carbide, or carbo-nitride derivative thereof (thus forming the third component); in this way, the elemental form of the third component acts essentially as a precursor of the third component. It should be understood that, in the case where the elemental form of the third component is sprayed, the deposited heating layer may in some embodiments comprise both the third component and its elemental form.

A third component in elemental form may also be a mixture of two or more materials. Exemplary mixtures include, without limitation, mixtures of boron and strontium, silicon and boron, titanium and boron, and boron and yttrium. The third component or elemental form thereof may be mixed with the first metallic component prior to use in the coating process, e.g., by mixing powders together to form the feedstock for thermal spraying, or during the coating process. Alternatively, the first and third components (or elemental forms thereof) may be present together in an alloy, optionally in the presence of additional metals or metalloids, the alloy being used as the feedstock. Non-limiting examples of alloys or mixtures including the [symbol] first and third components (or elemental forms thereof) for use as feedstock for thermally [symbol] spraying a resistive heating layer of the invention include CrAlY, NiAlY, CoCrAlY, NiCrAlY, [symbol] NiCoCrAlY, CoNiCrAlY, NiCrAlCoY, FeCrAlY, FeNiAlY, FeNiCrAlY, NiMoAlY, [symbol] NiCrAlMoY, and NiCrAlMoFeY. Other alloys and mixtures are known by those skilled in the [symbol] t.

It should be understood that, during the coating process (e.g., thermal spraying with exposure to a gas containing one or more of oxygen, nitrogen, carbon, and boron), the molten elemental form of the third component may react with the gas to produce one or more oxide, nitride, carbide, boride, and carbo-nitride derivative thereof. The nature of the reacted third component is dependent on the amount and nature of the gas used in the deposition. For example, use of pure oxygen results in an oxide of the third component. In addition, a mixture of oxygen, nitrogen, and carbon dioxide results in a mixture of oxide, nitride, and carbide. The exact proportion of each depends on intrinsic properties of the third component and on the proportion of oxygen, nitrogen, and carbon in the gas. The extent of the reaction also depends on the spraying conditions. Thermal spraying conditions will be selected by a practitioner skilled in the art so that at least a portion of the elemental form of the third component is reacted, in an amount sufficient to desirably stabilize the resistivity of the resistive heating layer (or, in some embodiments, to desirably pin the grain boundaries of the first metallic component in the deposited resistive heating layer).

The amount of third component required to stabilize the resistivity of the resistive heating layer (or to desirably pin the first metallic component's grain boundaries) will vary depending on many factors such as materials chosen for the resistive heating layer and the method by which the layer or coating is deposited, as is known by those of skill in the art. In particular embodiments, the material or feedstock for spraying includes about 0.4% or more of the third component or the elemental form thereof. In some embodiments, the material or feedstock to be sprayed includes from about 0.4% to about 2% of the third component (or the elemental form thereof), from about 0.4% to about 1% of the third component (or the elemental form thereof), or about 0.5% of the third component (or the elemental form thereof). More or less of the third component (or the elemental form thereof) may be included in the material or feedstock to be sprayed as long as the desired performance parameters of the heater or resistive heating layer are not adversely affected.

Similarly, in particular embodiments the resistive heating layer includes about [symbol] 4% or more of the third component; from about 0.4% to about 2% of the third component; [symbol] from about 0.4% to about 1% of the third component; from about 0.2% to about 0.5% of the [symbol] third component; about 0.1% or more of the third component; or about 0.5% of the third component. It will be understood that the amount of the third component in the resultant resistive heating layer will depend on how much of the third component reacts (or how much of the third component's elemental form reacts) with the gas during spraying and other process conditions as well as the starting material or feedstock.

In some embodiments, the resistivity of the resistive heating layer is stabilized by the third component such that it increases by no more than about 0.05% to about 1.5% during heating from about 25° C. to about 400° C. For example, the resistivity of the resistive heating layer (or the resistive heater) may increase by no more than about 0.05%, about 0.1%, about 0.2%, about 0.5%, about 1%, about 1.25%, or about 1.5% during heating from about 25° C. to about 400° C. In an embodiment, the resistivity of the resistive heating layer (or the resistive heater) increases by no more than about 0.05% to about 1.25%, by no more than about 0.08% to about 0.12%, or by no more than about 0.1% during heating from about 25° C. to about 400° C. In another embodiment, the resistivity of the resistive heating layer (or the resistive heater) increases by about 0.05% or less, about 0.1% or less, about 0.2% or less, about 0.5% or less, about 1% or less, about 1.25% or less, or about 1.5% or less during heating from about 25° C. to about 400° C. As one illustrative example, resistivity may increase by 0.1 ohms or less over 8 ohms starting at 25° C. and heating to 400° C. This is in contrast to known heating elements and to resistive heating layers lacking the third component that typically show a 10-20% increase in resistivity during heating over that range. In some embodiments, “the resistivity is stabilized” means that resistivity does not increase substantially during heating, e.g., does not increase by more than about 1.25% to about 1.5% during heating from about 25° C. to about 400° C. Alternatively, change in resistivity may be expressed in terms of % change per degree of heating; thus in some embodiments, the resistivity of the resistive heating layer does not increase by more than about 0.003% per ° C., or increases by about 0.003% per ° C. or less, during heating. In some embodiments, the resistivity of the resistive heating layer may increase during heating by about 0.004% per ° C. or less, 0.0027% per ° C. or less, 0.0013% per ° C. or less, or 0.00027% per ° C. or [symbol] ss, etc. In an embodiment, the resistivity of the resistive heating layer increases during heating [symbol] from about 0.00004 to about 0.00006% per ° C., or by about 0.00005% per ° C.

In particular embodiments, third components of the invention may include any materials that are capable of pinning the grain boundaries of the first metallic component(s) deposited in the resistive heating layer. Typically, in such embodiments the third component is [symbol] metal, a metalloid, a ceramic, or a rare-earth element, although other materials may be used. In general, any material that forms a hard nodule in the deposited grain matrix, such as an insoluble particle or precipitate, can act to pin grain boundaries and prevent grain growth during heating. Exemplary such third components include, without limitation, a boride, oxide, nitride, carbide, or carbo-nitride derivative of actinium (Ac), boron (B), carbon (C), hafnium (Hf), lanthanum (La), lutetium (Lu), molybdenum (Mo), niobium (Nb), palladium (Pd), rubidium (Rb), rhodium (Rh), ruthenium (Ru), scandium (Sc), strontium (Sr), tantalum (Ta), technetium (Tc), titanium (Ti), yttrium (Y), or zirconium (Zr), as well as mixtures and alloys thereof. Further exemplary third components include, without limitation, hafnium diboride, lanthanum oxide, lutetium oxide, strontium oxide, strontium nitride, scandium oxide, tantalum diboride, titanium nitride, titanium dioxide, titanium(II) oxide, titanium(III) oxide, titanium diboride, yttrium oxide, yttrium nitride, yttrium diboride, yttrium carbide, zirconium diboride, and zirconium silicide, as well as mixtures and alloys thereof.

In particular embodiments, third components of the invention may include any materials that are capable of desirably altering the structure of the aluminum oxide grains deposited in the resistive heating layer. Typically, in such embodiments the third component is a metal, metalloid, ceramic, or rare-earth element, although other materials may be used. Exemplary such third components include, without limitation, actinium (Ac), cerium (Ce), lanthanum (La), lutetium (Lu), scandium (Sc), unbiunium (Ubu), and yttrium (Y), as well as mixtures and alloys thereof. Further, such a third component may be a mixture of two or more of these materials. Exemplary mixtures include, without limitation, mixtures of scandium and yttrium, lanthanum and scandium, and lanthanum and cerium. The third component may be mixed with the first metallic component prior to use in the coating process, e.g., by mixing powders together to form the feedstock for thermal spraying. Alternatively, the first and third components may be present together in an alloy, optionally in the presence of additional metals [symbol] or metalloids, the alloy being used as the feedstock. Non-limiting examples of alloys and mixtures including the first and third components for use as feedstock for thermally spraying a resistive heating layer in such embodiments include CrAlY, NiAlY, CoCrAlY, NiCrAlY, NiCoCrAlY, CoNiCrAlY, NiCrAlCoY, FeCrAlY, FeNiAlY, FeNiCrAlY, NiMoAlY, NiCrAlMoY, and NiCrAlMoFeY. Other alloys and mixtures are known by those skilled in the [symbol] t. It should be understood that in such embodiments, during the coating process (e.g., thermal spraying with exposure to a gas containing one or more of oxygen, nitrogen, carbon, and boron), the molten third component may also react partially with the gas to produce one or more oxide, nitride, carbide, and boride derivative thereof. For example, scandium (III) oxide, yttrium (III) oxide, lanthanum (III) oxide, or lutetium (III) oxide may be formed during the coating process when the third component is exposed to oxygen. Further, thermal spraying conditions will be selected by a practitioner skilled in the art so that at least a portion of the third component remains unreacted, in an amount sufficient to desirably alter the aluminum oxide grain structure in the resistive heating layer. The amount of third component required to desirably alter the aluminum oxide grain structure will vary depending on many factors such as materials chosen for the resistive heating layer and the method by which the layer or coating is deposited, as is known by those of skill in the art.

A first metallic component and a third component for use in the resistive heating layer of the invention will be chosen by a practitioner skilled in the art, based on considerations generally known in the art such as the desired resistivity of the heater layer and the coating process being used.

### Thermal Spray

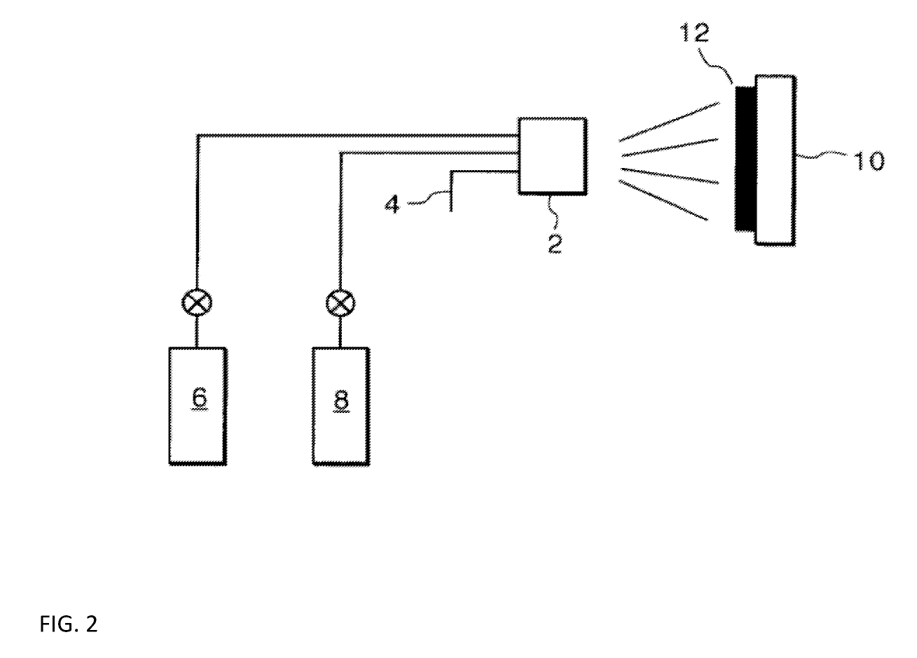

Resistive heating layers and other layers of a coating of the present invention are desirably deposited using a thermal spray apparatus. Exemplary thermal spray apparatuses include, without limitation, arc, plasma, flame spray, Rockide systems, arc wire, and high velocity oxy-fuel (HVOF) systems. A typical HVOF wire system consists of a gun or spray head where three separate gases come together (see FIG. 2). Propane gas and oxygen are commonly used as fuel gases, and the gas chosen as the reactant gas is used to accelerate the molten droplets and cool the spray nozzle in the gun. Normally, this last function is accomplished through the use of air. The gases are fed to the spray head through flow meters and pressure regulators or through mass flow controllers so that there is a controlled, independent flow for each gas. If it is desired to deliver reduced amounts of reactant gas, it can be mixed with a nonreactant gas, for example, [symbol] gon, so that the volume and flow are sufficient to operate the gun at appropriate velocities. The mixing may be accomplished by flowmeters and pressure regulators, mass flow controllers, or by [symbol] the use of pre-mixed cylinders, each of which is generally known to a practitioner skilled in the [symbol] t. The feedstock, which is wire in the embodiment shown in FIG. 2, is supplied to the gun head [symbol] means of a wire feeder that controls the rate at which material is delivered to the gun. The gun [symbol] self may be attached to a motion control system such as a linear translator or multiaxis robot.

In some embodiments, a twin wire arc system, such as the SmartArc™ twin wire arc system (Oerlikon Metco, Winterthur, Switzerland), is used. In some embodiments, a plasma spray system is used.

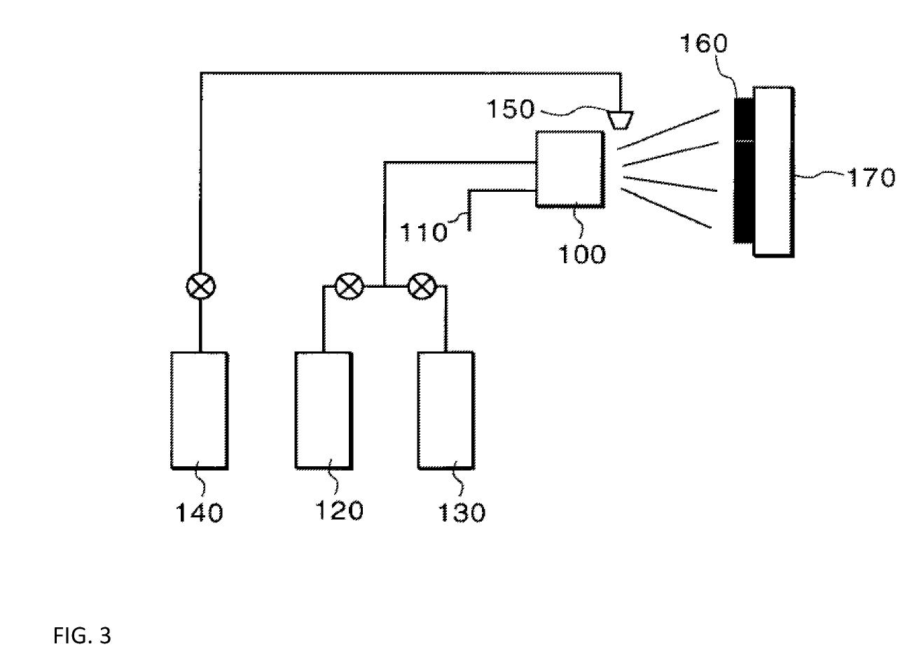

The thermal spray apparatus is desirably configured so that a reaction gas may be injected into the molten flux stream of the spray. For combustion systems and arc wire systems, this injection may be accomplished by using the gas as the accelerator. For plasma systems, if the plasma gases do not serve also as the reaction gas, the gas may be injected using an additional nozzle (see FIG. 3). Incorporating additional nozzles for injection of reactant gases is also applicable to other systems. Alternatively, the spraying process can be performed in an atmosphere rich in or wholly comprised of the reactant gas.

The composition of the deposited layer may be influenced by the type of thermal spray apparatus used. For example, droplets are emitted very rapidly from an HVOF system in comparison to other techniques, and these droplets are consequently exposed to reactants for a shorter period of time and thus react with the gas to a lesser extent. In addition, layers deposited by HVOF have higher adhesion strength than layers deposited by other systems.

Resistive layers may be deposited in defined patterns on a substrate. The pattern may be defined, for example, by a removable mask. Patterned application allows for the fabrication of more than one spatially separated resistive heating layer on one or more substrates. Patterned layers also allow controlled heating in localized areas of a substrate. Coatings having a resistivity that is variable, e.g., a continuous gradient or step function, as a function of location on a substrate, may also be produced. For example, the resistivity of the heating layer may increase or decrease by 50, 100, 200, 500 or 1000% over a distance of 1, 10, or 100 cm. The apparatus used may include a thermal spray gun and a gas source, the gas source including two or more gases that can be mixed in any arbitrary combination. By controlling the composition of the gas used in the thermal spray gun, the composition, and therefore resistivity, of the coating is controlled. For example, a gradual increase in a reactant in the gas (e.g., oxygen) leads to a gradual increase in the resistivity of the coating. This gradual increase can be used to produce a [symbol] ating having a gradient of resistivity on a substrate. Similarly, other patterns, e.g., step [symbol] nctions, of resistivity may be formed by appropriate control of the mixture of gases. The mixture of gases may include more than one reactive species (e.g., nitrogen and oxygen) or a [symbol] reactive and an inert species (e.g., oxygen and argon). A computer may also be used to control the mixing of the gases.

As used herein, a “substrate” refers to any object on which a resistive heating layer is deposited. A substrate may be, e.g., bare ceramic, or it may have one or more layers, e.g., an electrically insulating layer, on its surface.

The thermal spray process results in a characteristic lamellar microstructure of a coating. In the thermal spray process, a flux of molten droplets is created from the feedstock, which are accelerated and directed towards the substrate. The droplets, typically moving at speeds of several hundred meters per second, impact the substrate and very rapidly cool at rates approaching one million degrees per second. This rate of cooling causes very rapid solidification. Nevertheless, during the impact, the droplets deform into platelet-like shapes and stack on top of each other as the spray head is traversed back and forth across the substrate to build up the coating. The microstructure thus assumes a layered configuration, with the flattened particles all aligned parallel to the substrate and perpendicular to the line of deposition.

If the material being deposited undergoes no reactions with the gases present in the flux stream, then the composition of the coating is identical to that of the feedstock. If, however, the molten droplets react with an ambient gas during the deposition process, the composition of the coating differs from that of the feedstock. The droplets may acquire a surface coating of the reaction product, which varies in thickness depending, for example, on the rate of reaction, the temperatures encountered, and the concentration of the gas. In some cases, the droplets react completely; in other cases, the droplets have a large volume fraction of free metal at their centers. The resulting microstructure of the coating is a lamellar structure, one consisting of individual particles of complex composition. The coating has a reduced volume fraction of free metal with the remainder consisting of reaction products distributed in general as material surrounding the free metal contained in each platelet-like particle.

In the presence of the third component, the free metal is interspersed with the third component in the resistive heating layer, the third component being dispersed in the resistive heating layer and stabilizing the resistivity of the heating layer. In some embodiments, [symbol] the presence of the third component, the free metal is interspersed with the third component in [symbol] e resistive heating layer, the third component being dispersed at the grain boundaries and [symbol] inning the grain boundaries of the underlying metallic components and thus stabilizing the heating layer. In some embodiments, in the presence of the third component, the aluminum oxide grains are deposited in a columnar shape and pack closely together, overlying the unoxidized, “free” first metallic component/aluminum, and providing a protective barrier against oxidation or further oxidation of the underlying metallic components.

When the gases that are added to the flux stream are chosen to form reaction products, which have a much higher electrical resistivity, then the resultant coating exhibits a bulk resistivity that is higher than the free metallic component. In addition, when the concentration of gas is controlled, thereby controlling the concentration of reaction product, the resistivity of the coating is controlled proportionately. For example, the resistivity of aluminum sprayed in pure oxygen is higher than that sprayed in air because there is a higher concentration of aluminum oxide in the layer and aluminum oxide has a very high resistivity. Further, in some embodiments where the third component of the invention is included in the feedstock, then the aluminum oxide may be deposited in grains having a fairly uniform columnar shape and size that pack closely together, protecting the remaining free metallic components in the resultant coating from oxidation or further oxidation.

### Applications

Coatings.

Coatings on substrates can comprise resistive heating layers of the invention. In addition, other layers may be present in a coating to provide additional properties. Examples of additional coatings include, without limitation, an adhesion layer (e.g., nickel-aluminum alloy), an electrically insulating layer (e.g., aluminum oxide, zirconium oxide, or magnesium oxide), an electrical contact layer (e.g., copper), a thermally insulating layer (e.g., zirconium dioxide), a thermally emissive coating (e.g., chromium oxide), layers for improved thermal matching between layers with different coefficients of thermal expansion (e.g., nickel between aluminum oxide and aluminum), a thermally conductive layer (e.g., molybdenum), and a thermally reflective layer (e.g., tin). These layers may be located between the resistive heating layer and the substrate (e.g., adhesion layers) or on the side of the resistive heating layer distal to the substrate. Resistive heating layers may also be deposited on a non-conducting surface without an electrically insulating layer.

Heaters.

A resistive heating layer may be made into a resistive heater by coupling a power supply to the layer. Application of a current through the resistive layer then generates heat resistively. Connections between the power supply and the resistive heating layer are made, for example, by brazing connectors, soldering wires, or by physical contact using various mechanical connectors. These resistive heaters are advantageous in applications where localized heating is desired.

For example, one application of a resistive heater or heating layer of the invention is in injection molding. An injection mold has a cavity into which a melt of a thermoplastic material is forced. Once the material cools and hardens, it can be removed from the mold, and the process can be repeated. An injection mold of the invention can have a coating containing a resistive heating layer on at least a portion of the surface of the cavity. The resistive heating layer may be covered with a metal layer (e.g., molybdenum or tungsten). The purpose of placing a resistive heating layer in the cavity of a mold and in the conduits to that cavity is to better control the solidification process and reduce cycle times. Heaters in close proximity to the melt can be used to keep the melt hot so that it flows better with less pressure, and to cool the melt during the solidification phase in a controlled way.

Another application of a resistive heater or heating layer of the invention is in heated rollers. Heated rollers are used in many industries including papermaking, printing, laminating, and paper, film, and foil converting industries. One application of a resistive heater or heating layer of the invention is in dryers in paper manufacturing. Paper is manufactured in several stages, including forming, pressing, and drying. The drying stage typically removes water remaining from the pressing stage (typically about 30%) and reduces the water content typically to about 5%. The drying process typically involves contacting both sides of the paper with heated cylindrical rollers. Accordingly, a roller for a paper dryer having a resistive heating layer may be produced by methods of the invention. A coating containing a resistive heating layer is deposited on the interior or exterior of such a roller. Other coatings such as anticorrosive coatings may also be applied. The heater may be applied in a defined pattern through masks in the deposition step. [symbol] for instance, a pattern of zones that concentrates heat at the ends of the roller provides a more aiform heat to the paper since the ends cool more quickly than the center of the roller. examples of rollers that contain heating zones are given in U.S. Pat. No. 5,420,395, hereby incorporated by reference in its entirety.

The deposited resistive heaters or heating layers may be applied to a dryer can [symbol] r roller) used in the paper making process to remove water from pulp. In one example, the heaters are applied to the inside surface of a steel roller or can. First, an insulator layer of aluminum oxide is applied by thermal spray and sealed with nanophase aluminum oxide or some other suitable high temperature dielectric sealant. Then, the resistive heating layer is deposited using a high velocity oxy-fuel wire spray system, titanium wire, and nitrogen gas. The terminals are secured to the inside of the can by welding or threaded studs and are insulated such that electrical power may be applied to the deposited resistive heating layer. Finally, the entire resistive heating layer is coated with high temperature silicone or another layer of thermally sprayed aluminum oxide, which is sealed as before.

Alternatively, the resistive heating layer and insulator layers may be applied to the outside surface of the dryer can and coated with a thermally sprayed metallic layer, such as nickel. The nickel is then ground back to the desired dimension. For smaller heated roller applications, a metal casing may be affixed or shrunk onto the roller with its heaters applied.

Another application of a resistive heater or heating layer of the invention is in semiconductor wafer processing. A semiconductor wafer processing system of the invention includes a chamber, one or more resistive heaters, and means for mounting and manipulating a semiconductor wafer. The system may be used in wafer processing applications such as annealing, sintering, silicidation, glass reflow, CVD, MOCVD, thermal oxidation, and plasma etching. A system including such a heater is also useful for promoting reactions between wafers and reactive gases, for example, oxidation and nitridation. In addition, the system may be used for epitaxial reactions, wherein a material such as silicon is deposited on a heated surface in monocrystalline form. Finally, such a system allows chemical vapor deposition of the product of a gas phase reaction in amorphous form on a heated substrate.

Many additional applications of the heaters of the invention are possible. For example, additional applications include: blanket heater on pipe with metal contact layer on top and aluminum oxide insulator on the contact; heater tip for natural gas igniter on kitchen stove, [symbol] ven, water heater or heating system; free standing muffle tube fabricated by spray forming on a removable mandrel; and a low voltage heater coating for bathroom deodorizer.

Laboratory applications are also possible, such as resistively heated coated glass and plastic lab vessels; work trays; dissection trays; cell culture ware; tubing; piping; heat exchangers; manifolds; surface sterilizing laboratory hoods; self-sterilizing work surfaces; sterilizing containers; heatable filters; frits; packed beds; autoclaves; self-sterilizing medical bacterial and tissue culture tools (e.g., loops and spreaders); incubators; benchtop heaters; flameless torches; lab ovens; incinerators; vacuum ovens; waterbaths; drybaths; heat platens; radiography pens; reaction vessels; reaction chambers; combustion chambers; heatable mixers and impellors; electrophoresis equipment; anode and cathode electrodes; heating electrodes; electrolysis and gas generation systems; desalinization systems; deionizing systems; spectroscopy and mass spectroscopy equipment; chromatography equipment; HPLC; IR sensors; high temperature probes; thermoplastic bags; cap and tube sealers; thermal cyclers; water heaters; steam generation systems; heated nozzles; heat activated in-line valves; shape-memory alloy/conductive ceramic systems; lyophilizers; thermal ink pens and printing systems.

Medical and dental applications are also possible, such as self-sterilizing and self-cauterizing surgical tools (e.g., scalpel blades, forceps); incubators; warming beds; warming trays; blood warming systems; thermally controlled fluid systems; amalgum heaters; dialysis systems; phoresis systems; steamer mops; ultra high temperature incineration systems; self sterilizing tables and surfaces; drug delivery systems (e.g., medicated steam inhaler; thermal activated transcutaneal patches); dermatological tools; heatable tiles; wash basins; shower floors; towel racks; mini-autoclaves; field heater cots; and body warming systems.

Industrial applications are also possible, such as sparkless ignition systems; sparkless combustion engines; bar heaters; strip heaters; combustion chambers; reaction chambers; chemical processing lines; nozzles and pipes; static and active mixers; catalytic heating platforms (e.g., scrubbers); chemical processing equipment and machines; environmental remediation systems; paper pulp processing and manufacturing systems; glass and ceramic processing systems; hot air/air knife applications; room heaters; sparkless welding equipment; inert gas welding equipment; conductive abrasives; heater water-jet or liquid-jet cutting systems; heated impellers and mixing tanks; fusion and resistance locks; super heated fluorescent bulbs that use new inert gases; heatable valves; heatable interconnects and interfaces of all types; [symbol] eatable ceramics tiles; self heating circuit boards (e.g., self-soldering boards; self-laminating [symbol] ards); fire hydrant heaters; food processing equipment (e.g., ovens, vats, steaming systems, [symbol] aring systems, shrink wrapping systems, pressure cookers, boilers, fryers, heat sealing systems); in-line food processing equipment; programmable temperature grids and platens to selectively apply heat to 2-D or 3-D structures (e.g., thermoplastic welding and sealing systems); [symbol] oint pulsing heaters; battery operated heaters; inscribers and marking systems; static mixers; steam cleaners; IC chip heaters; LCD panel heaters; condensers; heated aircraft parts (e.g., wings, propellers, flaps, ailerons, vertical tail, rotors); conductive ceramic pens and probes; self-curing glazes; self-baking pottery; walk-in-ovens; self-welding gaskets; and heat pumps.

Home and office applications are also possible, such as heatable appliances of all types; self-cleaning ovens; igniters; grills; griddles; susceptor-based heatable ceramic searing systems for microwave ovens; heated mixers; impellers; stirrers; steamers; crock pots; pressure cookers; electric range tops; refrigerator defrost mechanisms; heated ice cream scoops and serving ladles; operated hand-held heaters and warmers; water heaters and switches; coffee heater systems; heatable food processors; heatable toilet seats; heatable towel racks; clothes warmers; body warmers; cat beds; instantly heated irons; water bed heaters; washers; driers; faucets; heated bathtubs and wash basins; dehumidifiers; hose nozzles for heated washing or steam cleaning; platens to heat moisturized wipes; bathroom tissue heaters; towel heaters; heated soap dispensers; heated head razors; evaporative chilling systems; self-heating keys; outdoor CO₂ and heat generating systems for bug attraction and killing systems; aquarium heaters; bathroom mirrors; chair warmers; heatable blade ceiling fans; and floor heaters.

Additional heater applications include whole surface geometric heaters; direct contact heaters; pure ceramic heating systems; coated metal heating systems; self-detecting fault systems; plasma sprayed thermocouples and sensors; plasma spherodized bed reaction systems (e.g., boron gas generation system for the semiconductor industry; heatable conductive chromatographic beds and beads systems); pre-heaters to warm surfaces prior to less costly or more efficient heating methods; and sensors (e.g., heater as part of integrated circuit chip package).

Microwave and electromagnetic applications are also possible, such as magnetic susceptor coatings; coated cooking wear; magnetic induction ovens and range tops.

Thermoplastic manufacturing applications are also possible, such as resistively heated large work surfaces and large heaters; heated injection molds; tools; molds; gates; [symbol] zzles; runners; feed lines; vats; chemical reaction molds; screws; drives; compression systems; extrusion dies; thermoforming equipment; ovens; annealing equipment; welding equipment; heat [symbol] nding equipment; moisture cure ovens; vacuum and pressure forming systems; heat sealing equipment; films; laminates; lids; hot stamping equipment; and shrink wrapping equipment.

Automotive applications are also possible, such as washer fluid heaters; in-line heaters and nozzle heaters; windshield wiper heaters; engine block heaters; oil pan heaters; steering wheel heaters; resistance-based locking systems; micro-catalytic converters; exhaust scrubbers; seat heaters; air heaters; heated mirrors; heated key locks; heated external lights; integral heater under paint or in place of paint; entry and exit port edges; sparkless “sparkplugs”; engine valves, pistons, and bearings; and mini-exhaust catalytic pipes.

Marine applications are also possible, such as antifouling coatings; de-iceable coatings (e.g., railings, walkways); electrolysis systems; desalinization systems; on-board seafood processing systems; canning equipment; drying equipment; ice drills and corers; survival suits; diving suit heaters; and desiccation and dehumidifying systems.

Defense applications are also possible, such as high temperature thermal targets and decoys; thermal locator systems; thermal beacons; remora heaters; MRE heating systems; weapons preheaters; portable heaters; cooking devices; battery powered heatable knives; noncombustion based gas expansion guns; jet de-icing coating on wings; thermal fusion self destruction systems; incinerators; flash heating systems; emergency heating systems; emergency stills; and desalinization and sterilization systems.

Signage applications are also possible, such as heated road signs; thermoresponsive color changing signs; and inert gas (e.g., neon) impregnated microballoons that fluoresce in magnetic fields.

Printing and photographic applications are also possible, such as copiers; printers; printer heaters; wax heaters; thermal cure ink systems; thermal transfer systems; xerographic and printing heaters; radiographic and photographic film process heaters; and ceramic printers.

Architectural applications are also possible, such as heated walkway mats; grates; drains; gutters; downspouts; and roof edges.

Sporting applications are also possible, such as heated golf club heads; bats; [symbol] icks; handgrips; heated ice skate edges; ski and snowboard edges; systems for de-icing and re- [symbol] ing rinks; heated goggles; heated glasses; heated spectator seats; camping stoves; electric grills; and heatable food storage containers.

Injection Moldings.

In one embodiment, the heaters of the present invention may be used in an injection molding system to manage and control the flow of the molten material throughout the mold cavity space. The heater may be deposited as part of a coating directly on the surface of the mold cavity area to precisely manage the temperature profile in the moving, molten material. For some applications, the heater may have variable resistivity across the surface of the mold cavity area to allow for fine adjustments to the molten material temperature gradient, thus providing precise heat flow control and constant (or precisely-managed) viscosity and velocity of the melt flow. Mold heat management and flow control depend on the specific application and the type of material used. Optionally, the heater is used in conjunction with a thermal sensor (e.g., a thermistor or thermocouple) and/or a pressure sensor. Direct deposit of the coating containing the heater onto the mold cavity area can reduce or eliminate air gaps between the heater and the heated surface, providing intimate and direct contact for improved temperature transfer between the heater and the heated surface.

Electric Grills.

In some embodiments, the heaters of the present invention may be used in an electric grill, or barbeque. The electric grill may use resistive heating layers of the invention in the form of coatings as a heat source. Electric grills have been used previously to alleviate the need for open flames and combustible gases, however electric grills that use wire type tubular elements are too inefficient at a common household voltage of 120 volts or 220 volts to provide adequate temperatures for searing meat over reasonably sized cooking areas. Further, the inefficiency of such electric grills prevents an electric grill from achieving the elevated temperatures necessary for performing cooking functions such as searing meat and from recovering back to cooking temperature after food has been distributed over the grilling surface.

Examples of electric grills incorporating resistive heaters or heating layers are described in U.S. Pat. No. 7,834,296 and U.S. Patent Application Publication No. 2011/0180527, the entire contents of each of which is hereby incorporated by reference. In principle, a grill will heat primarily by thermal conduction or primarily by thermal radiation (or by a combination of the two). In grills provided herein, heat is generated by passing an electrical current through a resistive heater or resistive heating layer of the invention.

When thermal conduction is the primary mode of heat transfer, the resistive heating layer can be disposed over a surface of the grill either on top of the grilling surface or on the underside of the grilling surface. Heat is generated by passing an electrical current through the resistive heating layer whereupon the heat is conducted directly to the food if the element is [symbol] the top surface of the grill or through the metal grilling surface and then to the food if the [symbol] element is on the bottom surface of the grill.

When thermal radiation is the primary mode of heat transfer, the film element can be disposed over a surface positioned either below the grilling surface or above the grilling surface. Here, electrical current passes through the film heating element such that the substrate upon which the element is deposited heats to a temperature sufficiently high for thermal radiation to be emitted in sufficient intensity to heat the food to the desired cooking temperature.

In brief, an electric grill typically contains a supporting structure for holding food thereon (i.e., a grate), means for draining grease or any other liquid that comes from food cooking on the electric grill, and a heater. In accordance with the present invention, the heater may be provided as, for example, but not limited to, a coating comprising a resistive heating layer of the invention. In one embodiment of the electric grill, among others, the electric grill has a grate, a first electrical insulator layer located above the grate, a resistive heating layer deposited on a top surface of the first electrical insulator layer, and a top layer located over the resistive heating layer for protecting the heating layer.

In some embodiments, a resistive heating layer (also referred to herein as a heater layer) is provided, for example, on a heat shield, on a support tray for ceramic briquettes or the like, or on a heater panel suspended from the hood of the grill. In one embodiment, an electric grill comprises a shaped metal sheet that can be formed by stamp pressing, for example, to provide a grill having a plurality of raised ridges. A plurality of heater layers can be provided on the raised ridges and connected in parallel by a pair of conductive traces. In yet another embodiment, a grill includes an odor-reducing device having a heater layer. The heater layers or resistive heating layers mentioned above are preferably provided as coatings, and can be made using many different coating technologies, although other methods may be used for providing the heater layers, as is known by those skilled in the art. Examples of coating techniques include, but are not limited to, thermal spray, of which many types are known in the art. performance of the coatings will depend on many factors such as materials chosen for the resistive heating layer, the dimensions of the heating element, and the method by which the [symbol] ating is deposited.

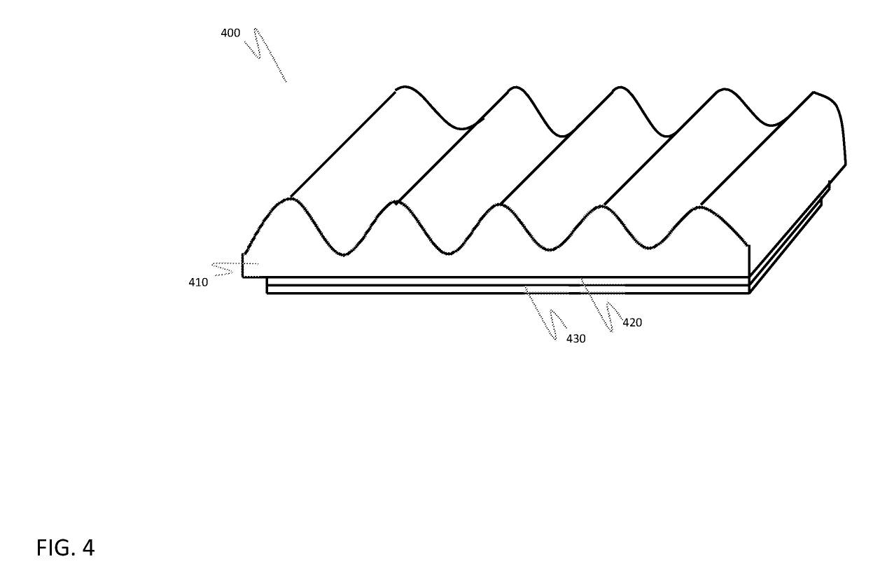

FIG. 4 is a schematic diagram illustrating an example of an electric grill 400, in accordance with one exemplary embodiment of the invention. As is shown in FIG. 4, the electric grill 400 contains a solid casting grate 410 on which food to be cooked is placed. An example of material that may be used for the solid casting grate 410 is aluminum. Of course, other known conductive materials such as cast iron, carbon steel or stainless steel may be used as well. An electrical insulator layer 420 (e.g., an electrical insulator coating) is located on a bottom portion of the solid casting grate 410. In addition, a heater layer 430 (e.g., a heater coating comprising a resistive heating layer) is deposited on a bottom portion of the electrical insulator layer 420, on a portion opposite the solid casting grate 410. In accordance with this exemplary embodiment of the invention, heat flows virtually unimpeded up from the heater layer 430, through the electrical insulator layer 420, to the solid casting grate 410. Of course, the solid casting grate 410 may be replaced by a casting grate that is not solid or simply shaped differently.

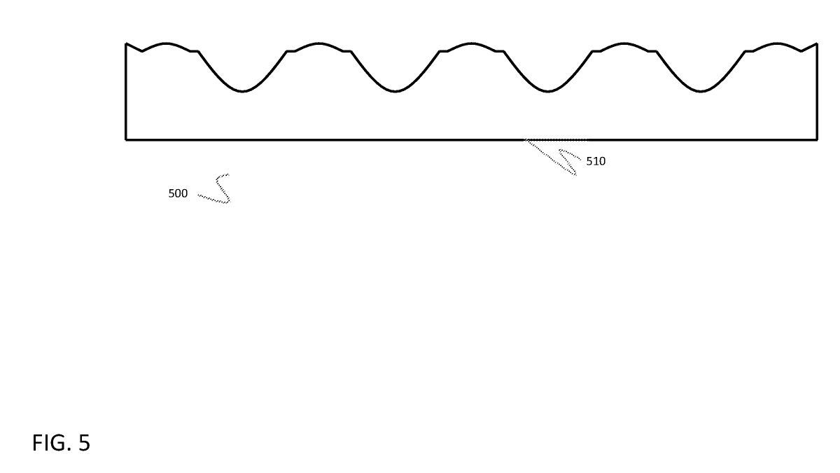

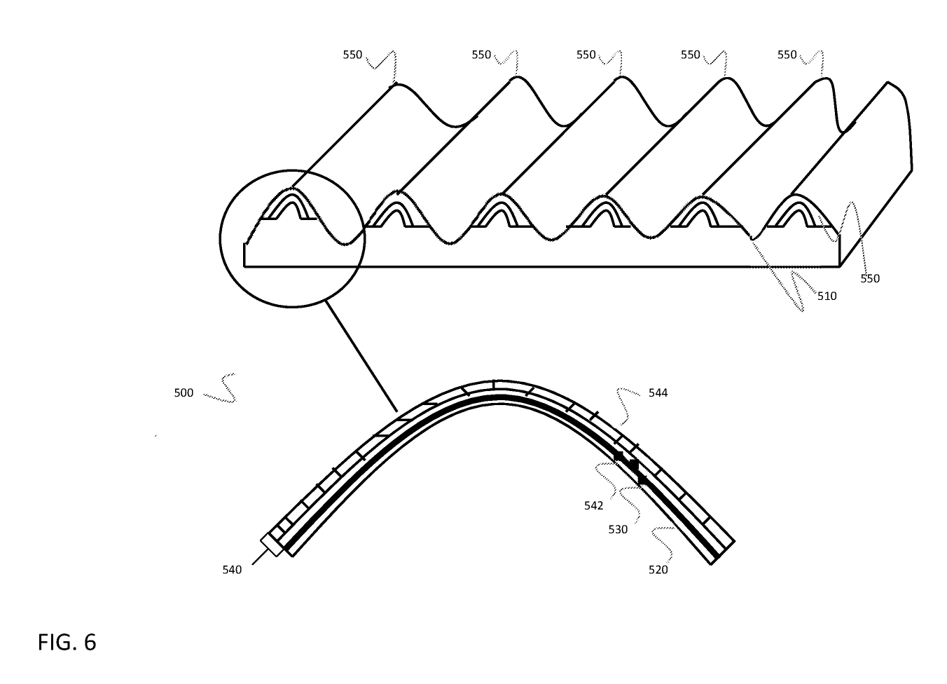

FIG. 5 is a schematic diagram illustrating another example of an electric grill 500 in accordance with another exemplary embodiment of the invention. As is shown by FIG. 5, the electric grill 500 contains a solid casting grate 510. FIG. 6 is a schematic diagram further illustrating the grate 510 without having layers deposited thereon, as is further explained herein.

Returning to FIG. 6, it can be seen that the grate 510 contains a series of ridges 550, which are raised portions of the grate 510. Other portions of the grate 510 are concave in shape. A first electrical insulator layer 520 (e.g., an electrical insulator coating) is located between the grate 510 and a heater layer 530 (e.g., a heater coating), where the heater layer 530 is deposited on a top surface of the first electrical insulator layer 520. Specifically, the first electrical insulating layer 520 is located on a top surface of the grate 510. In addition, the film heater layer 530 is located on a top surface of the first electrical insulating layer 520.

A top layer 540 is provided on a top surface of the heater layer 530 and may be provided as a coating or otherwise on the heater layer 530. The top layer 540 serves to protect the heater layer 530 from grease, other substances, and abuse. It should be noted that the top layer 540 may contain either a second electrical insulator layer 542 (e.g., a ceramic insulator), or [symbol] second electrical insulator layer 542 (e.g., ceramic insulator) and a metal layer 544 located on [symbol] p of the second electrical insulator layer 542. It should be noted that the top layer 540 prevents the user of the electric grill 500 from being exposed to electrical hazard.

The exemplary electric grill 500 of FIG. 6 shows that the first electrical insulator layer 520, the heater layer 530, and the top layer 540 are located within each ridge 550 of the electric grill 500. Therefore, there are a number of groups of the above-mentioned components, where each group is located beneath a ridge 550. Alternatively, the entire solid casting grate 510 may be covered with one first electrical insulator layer 520, one heater layer 530, and one top layer 540 (not shown).

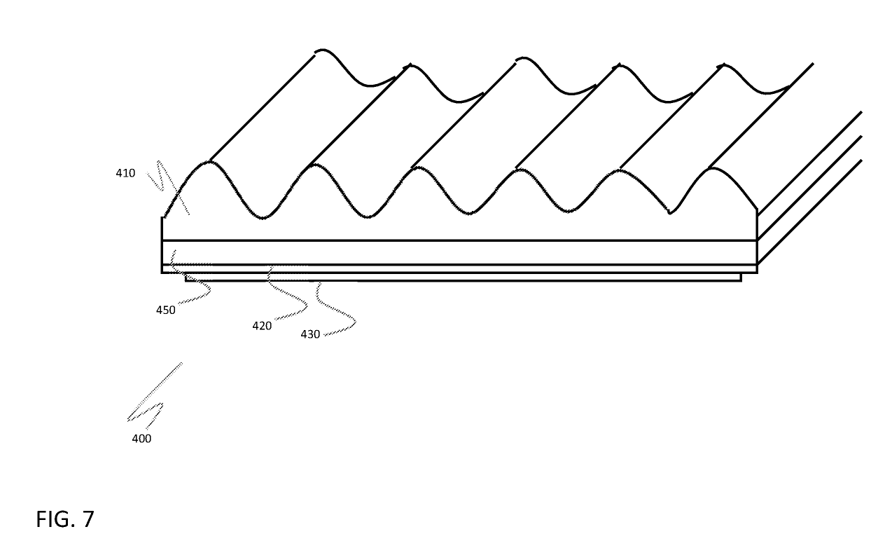

FIG. 7 is a schematic diagram illustrating a variation of the electric grill 400 of FIG. 4. Specifically, the electric grill 400 also contains a heater plate 450 located between the electrical insulator layer 420 (e.g., an electrical insulator coating) and the bottom portion of the solid casting grate 410. The heater plate 450 is capable of conducting heat (i.e., receiving energy) from the heater layer 430 and transferring the heat to the solid casting grate 410. It should be noted that the heater plate 450 may be removably connected to the solid casting grate 410 and/or the electrical insulator layer 420. Alternatively, the solid casting grate 410 may simply rest on the heater plate 450. In addition, in accordance with another alternative embodiment of the invention, the heater plate 450 may contain the heater layer 430 therein.

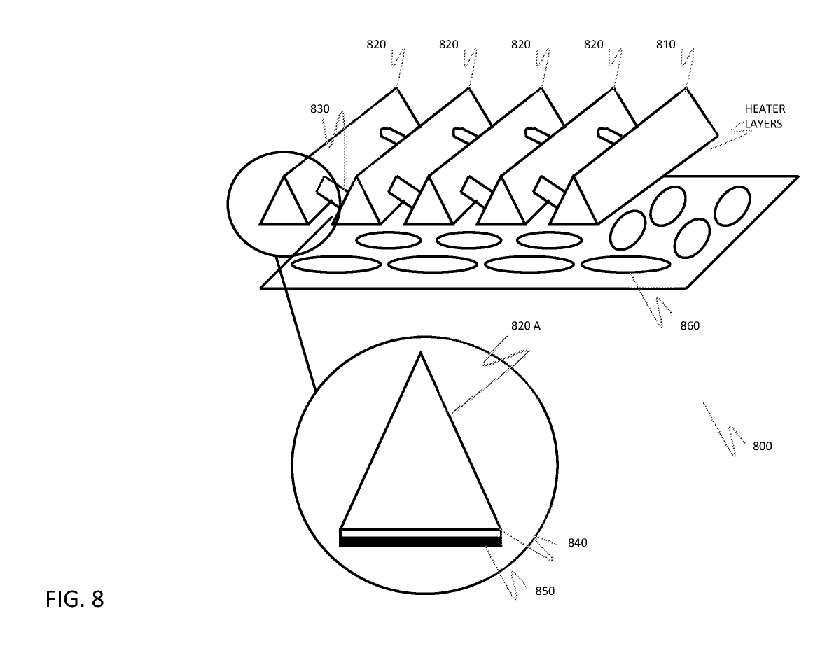

FIG. 8 is a schematic diagram illustrating an electric grill 800 in accordance with another exemplary embodiment of the invention. As is shown by FIG. 8, the electric grill 800 has a grate 810 having a different design from the grate 410 of FIG. 4. Specifically, the grate 810 contains a series of shaped rods 820 having connecting bars 830 connecting the shaped rods 820. Describing one shaped rod 820A, each shaped rod 820A has an electrical insulator layer 840 located on a bottom surface of the shaped rod 820A and a heater layer 850 located beneath the electrical insulator layer 840. It should be noted that ceramic tiles 860 may be positioned below the grate 810 for evaporating grease and other secretions from food being cooked on the electric grill 800. In addition, while FIG. 8 illustrates each shaped rod 820 as being triangular in shape, one having ordinary skill in the art would appreciate that the shaped rods 820 may be shaped differently.

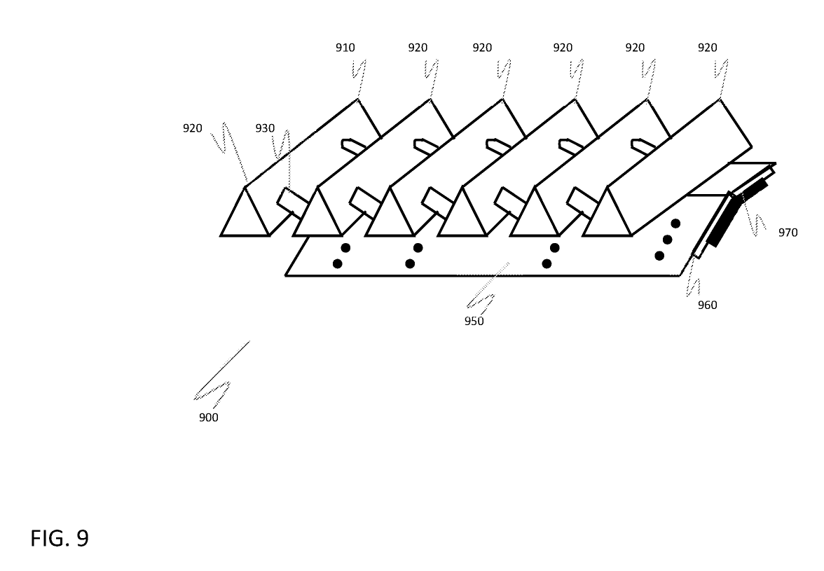

FIG. 9 is a schematic diagram illustrating an electric grill 900, in accordance with a fourth exemplary embodiment of the invention. As shown by FIG. 9, the electric grill 900 has a [symbol] ate 910 having a different design from the grate 410 of FIG. 4. Specifically, the grate 910 contains a series of shaped rods 920 having connecting bars 930 connecting the shaped rods 920. [symbol] heating plate 950 may be positioned below the grate 910 for purposes of radiating energy (i.e., providing heat) up to food positioned on the grate 910. The heating plate 950 may be shaped and [symbol] zed many different ways for purposes of radiating heat. An electrical insulator layer 960 is [symbol] cated below the heating plate 950 and a heater layer 970 is located beneath the electrical insulator layer 960.

The heating plate 950 can be in the form of a heat shield. Heat shields are commonly used in gas grills and are located between the gas burner and the cooking grate. The heat shield protects the burner from corrosive drippings, helps to disperse the heat more evenly across the surface of the grill, and can vaporize drippings to infuse the food with additional flavor. A conventional gas grill can be easily retrofitted into an electric grill by providing the layered heating element of the present invention on a heat shield, such as shown in FIG. 9.

Alternatively, the heating plate for 950, electrical insulator layer 960, and heater layer 970 may be located separate from the grate 910. As one example, the heating plate 950, electrical insulator layer 960, and heater layer 970 may be located above the grate 910, such as on a hood of a barbecue grill, or on a shelf like structure they can be positioned above food resting on the grate 910. In such an arrangement, energy radiates down to the food. Such a configuration would be ideal for broiling food resting on the grate 910.

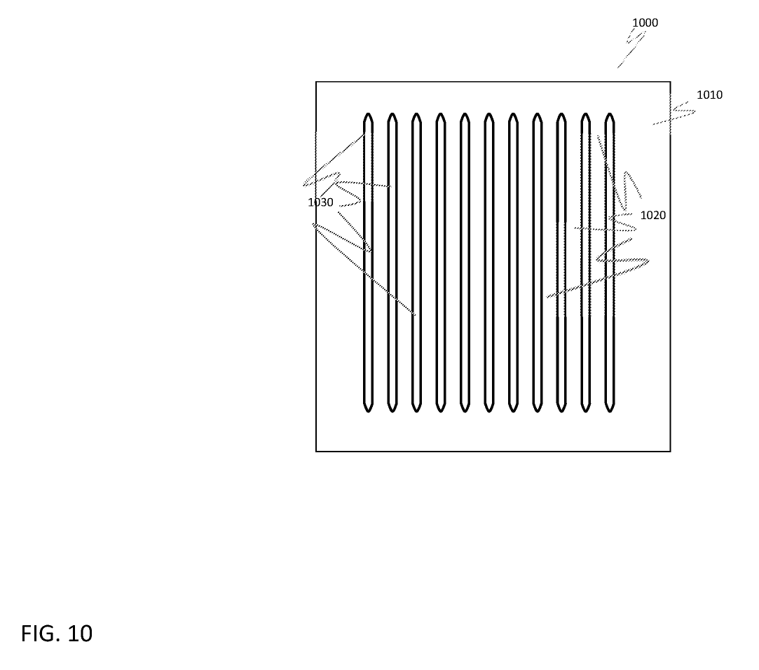

FIG. 10 is a schematic diagram illustrating an electric grill 1000 according to another embodiment of the present invention. In this embodiment, the grill 1000 is formed from a sheet of material, such as a metal sheet, that has been machined to produce a grate structure. In one embodiment, the sheet is a steel sheet, such as a 400 series stainless steel sheet, that has been machined by stamping the sheet to provide the grate structure. FIG. 10 is a top plan view of the grill 1000, which includes a generally flat portion 1010 extending around the edges of the grill and a series of parallel raised ridges 1020 extending through the central area of the grill 1000. The grill 1000 can include open spaces 1030 between the ridges 1020 that allow fat and grease from a food product on the grill 1000 to fall below the grill 1000.

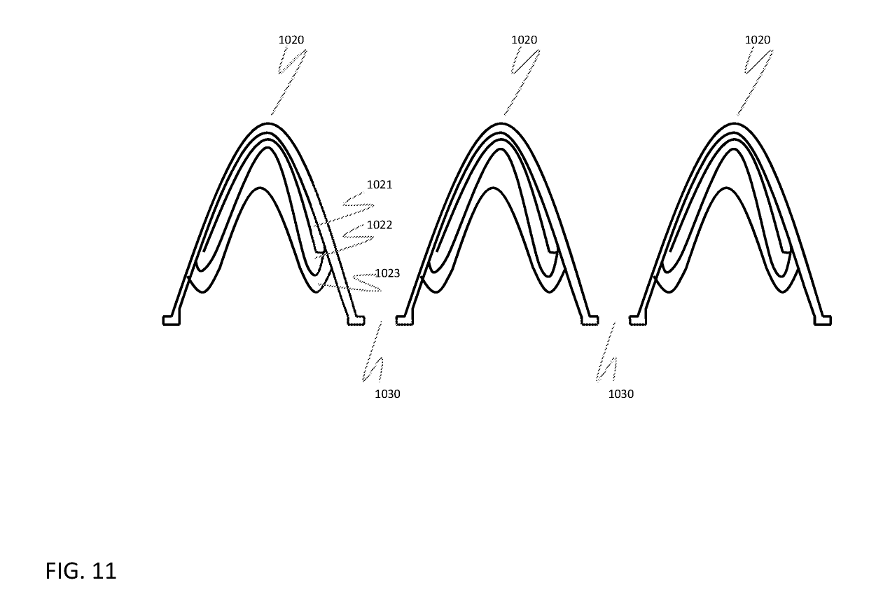

FIG. 11 is a cross section view of a plurality of ridges 1020 separated by open spaces 1030. In this embodiment, the ridges are relatively closely-spaced (e.g., about 3/16^{th} of [symbol] inch apart), but it will be understood that the ridges can have any suitable spacing. The ridges 1020 in this embodiment have an inverted “U” or “V” shape. On the underside of each ridge 1020 is a layered heating element that includes a first insulating layer 1021 located on the underside of the ridge 1020, a heater layer 1022 on the first insulating layer 1021 opposite the ridge 1020, and a second insulating layer 1023 on the heater layer 1021 opposite the ridge 1020. heat flows up from the heater layer 1022 through the first insulating layer 1021 and the ridge 1020 to heat a food item on the grill 1000. The grill 1000 according to this embodiment can be made from a relatively thin metal sheet. The machined sheet can have any suitable thickness, and can have a thickness of, for example, ½ inch or less, ¼ inch or less, ⅛ inch or less, 1/16 inch or less, or 1/32 inch or less. In one embodiment, the machined sheet has a thickness of between about 0.005 and 0.100 inches, and can be, for example, about 0.028 inches thick.

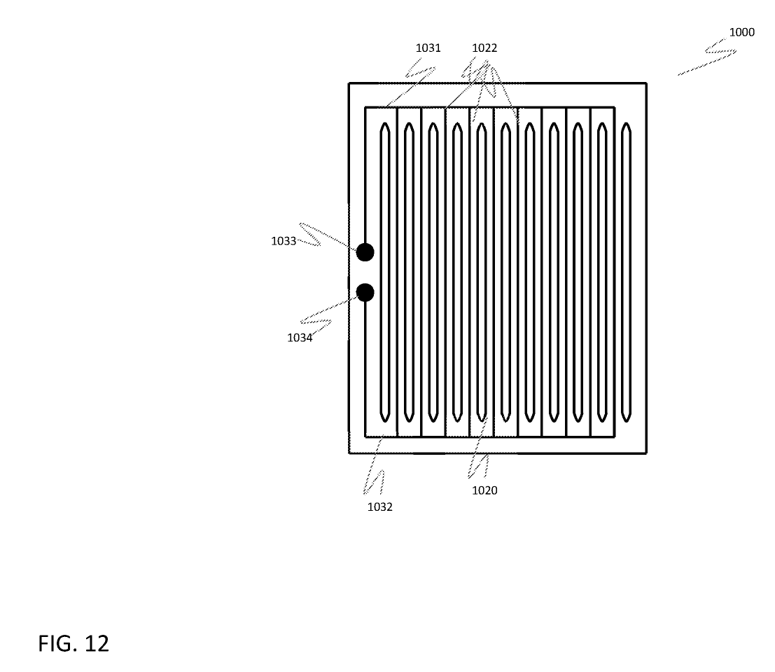

FIG. 12 is a plan view illustrating the underside of the grill 1000 of FIGS. 10 and 11. The heater layers 1022 are located on the underside of the parallel ridges 1020. A pair of electrical conductors, which can be conductive traces 1031, 1032, extend along opposing edges of the grill 1000, and connect each of the heater layers 1022 in a parallel circuit configuration. This parallel circuit configuration is advantageous in that the failure of one heating element will not cause the entire grill to fail. In the embodiment of FIG. 12, each of the conductive traces 1031, 1032 terminates at a respective electrical connector 1033, 1034. The connectors 1033, 1034 can be located adjacent to one another, such as shown in FIG. 12, to allow the grill 1000 to be easily connected to a power source. The conductive traces 1031, 1032 can comprise any suitable conductor, such as a wire or ribbon, or can comprise a coating of a conductive material that can be deposited on the grill 1000 by a suitable process, such as by spraying or screen printing.

The layered heating element can be encapsulated in a protective layer to protect the heating element from environmental damage and to provide electrical insulation. The protective layer can provide a waterproof seal, and the grill 1000 can be dishwasher-safe. The second insulating layer 1023 can serve as the protective layer, or one or more additional layers can be provided over the second insulating layer 1023 to provide the protective layer. In one embodiment, the protective layer can be a silicone material. Silicones constitute a class of materials that offer desirable engineering properties for layered heaters. Silicones can resist temperature extremes, moisture, corrosion, electrical discharge and weathering. Silicone materials also offer additional advantages for coatings applications. For example, they can be applied using inexpensive processes such as spray painting, dipping and brushing, and they can [symbol] cured using belt ovens operating at low temperatures. In one embodiment, both the first insulating layer 1021 and the second insulating layer 1023, which also serves as the protective layer, are comprised of silicone materials.

It has been found that despite having a relatively small thermal mass, the heating element in this thin-sheet embodiment is able to provide the requisite power for grilling food. By selecting the appropriate heater geometry and resistivity for the heater layer, the grill 1000 can easily heat to and sustain cooking temperatures as high as 900 degrees Fahrenheit using conventional household power (e.g., 100-240 V).

In an alternative to the embodiment of FIGS. 10-12, the first insulating layer 1021, the heater layer 1022 and the third insulating layer 1023 can be located on the top side of the ridges 1020, similar to the embodiment of FIGS. 5 and 6.

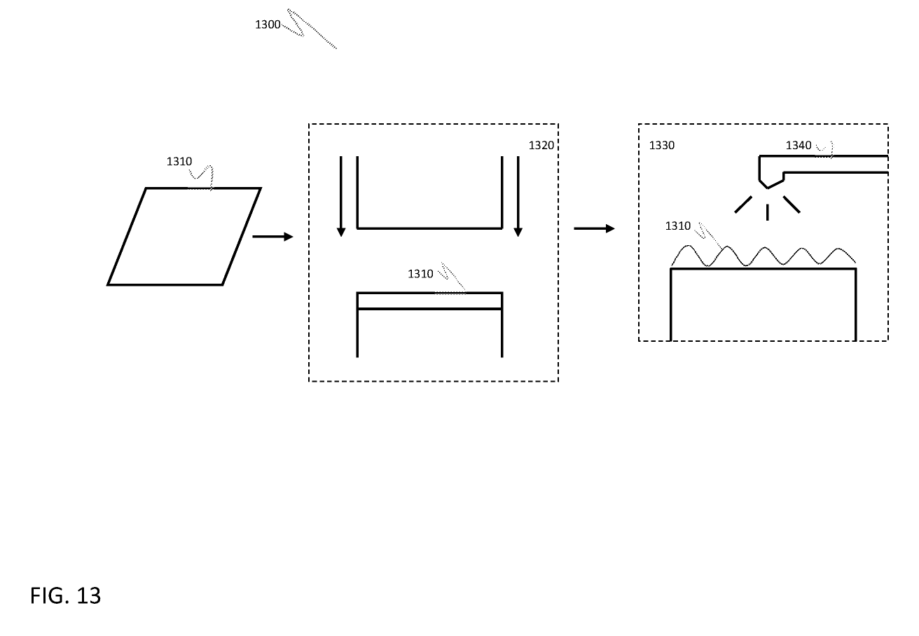

FIG. 13 illustrates a system 1300 and method for manufacturing an electric grill 1000 according to an embodiment of the invention. A metal sheet 1310, which can be a 400 series stainless steel sheet, is cut to the appropriate size, if necessary, and is then fed to a stamping press 1320 that is configured to deform and/or cut the metal sheet 1310 into the shape of the grill 1000 in one or more stages. The sheet 1310 is then fed to a processing station 1330 for providing various coatings to the underside of the metal sheet 1310 to produce an electric grill 1000. As shown in FIGS. 11 and 12, for example, heating elements 1022 and conductive traces 1031, 1032 can be provided in a desired pattern on the underside of the metal sheet 1310. The processing station 1330 can comprise one or more work areas having appropriate equipment for providing various coatings to the sheet 1310 in the appropriate sequence and patterns to produce the grill 1000.

In one embodiment, the resistive heating layer 1022 (FIG. 11) is deposited by thermal spray, and the processing station 1330 includes one or more thermal spray devices 1340 (also known as spray “guns”). In certain embodiments, the first insulating layer 1021 and the second insulating layer 1023 (FIG. 11) can also be formed by thermal spray. In other embodiments, one of both of the insulating layers 1021, 1023 are formed by a different technique, such as by spray painting, dipping or brushing a silicone material onto the metal sheet 1310.

The spray device 1340 can be an arc wire thermal spray system, which operates [symbol] melting the tips of two wires (e.g., zinc, copper, aluminum, or other metal) and transporting [symbol] resulting molten droplets by means of a carrier gas (e.g., compressed air) to the surface to be ated. The wire feedstock is melted by an electric arc generated by a potential difference between the two wires. The spray gun is arranged above the substrate 1310. The wire feedstock [symbol] in be supplied to the spray gun by a feeder mechanism that controls the rate at which the feedstock material is supplied to the gun. The carrier gas is forced through a nozzle in the spray gun and transports the molten droplets at high velocity to the substrate 1310 to produce the heating layer 1022. The carrier gas can be supplied by one or more pressurized gas sources. In a preferred embodiment, the carrier gas includes at least one reactant gas that reacts with the molten droplets to control the resistivity of the deposited layer. The reactant gas can be, for example, an oxygen, nitrogen, carbon or boron-containing gas that reacts with the metallic material (e.g., the first metallic component, e.g., aluminum in some embodiments) in the molten droplets to provide a reaction product that can increase the resistivity of the deposited layer relative to the resistivity of the feedstock material. In some embodiments, a gas may further comprise one or more of hydrogen, helium, and argon. The spray gun can be translated relative to the substrate 1310 in order to build up a coating layer over multiple passes. The gun 1340 can be attached to a motion control system such as a linear translator or multi-axis robot. A control system, preferably a computerized control system, can control the operation of the spray gun 1340.

Other known spray techniques can be used in the present invention to deposit the heater layer, including arc plasma spray systems, flame spray systems, high-velocity oxygen fuel (HVOF) systems, and kinetic, or “cold” spray systems.

The conductive traces 1031, 1032 (FIG. 12) can also be formed by spraying a conductive material onto the sheet 1310 in the appropriate pattern. Alternatively, the conductive traces 1031, 1032 can be formed by depositing a conductive material using another technique, such as by screen printing. After the heating layer(s) 1022 and conductive traces 1031, 1032 have been applied to the sheet 1310, a protective layer of an insulating material, such as silicone, can be applied to insulate and protect the electronic components of the grill 1000.

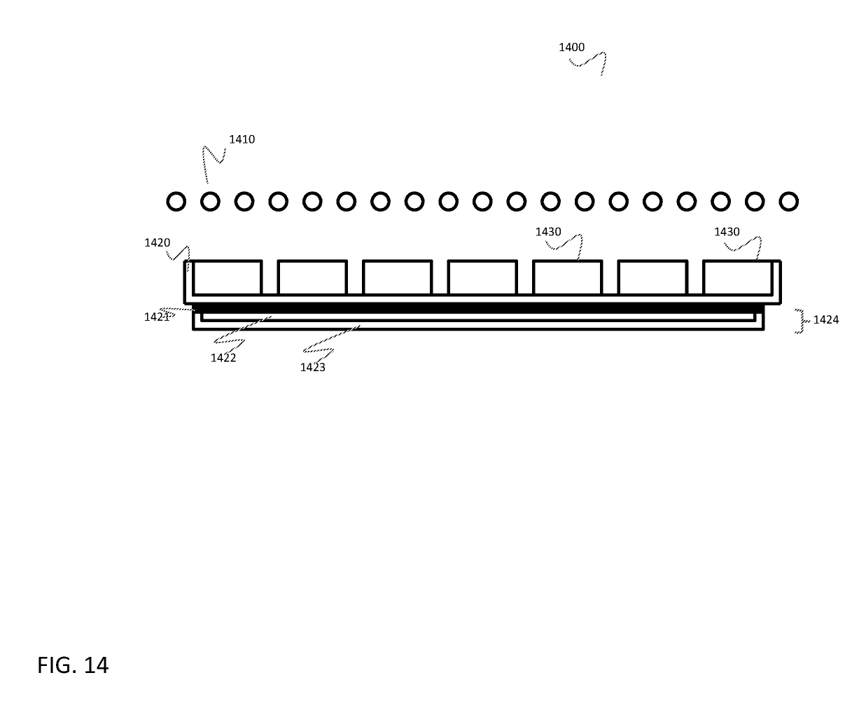

FIG. 14 illustrates an electric grill 1400 according to another embodiment of the invention. In this embodiment, the grill 1400 includes a cooking grate 1410, which can be any conventional grill cooking surface, and a supporting tray 1420 located beneath the grate 1410, [symbol] nd holding a plurality of ceramic tiles or briquettes 1430. A layered heating element 1424, which can comprise a first insulating layer 1421, a resistive heating layer 1422, and a second insulating overcoat 1423, such as described above in connection with FIGS. 4-13, is provided on [symbol] least one surface of the supporting tray 1420. In the embodiment of FIG. 14, the layered [symbol] eating element 1424 is provided on the bottom surface of the tray 1420, though it will be understood that the heating element can be provided on any surface(s) of the tray 1420. When the heating element 1424 is electrically energized, heat from the heating layer 1422 is conducted to the briquettes 1430, which, in turn, radiate heat upwards to the food positioned on the grate 1410. The briquettes 1430 can also evaporate grease and other secretions that drip down from the food. It will be understood that in addition to ceramic briquettes, other suitable materials for radiating heat, such as lava rocks, could be positioned on the supporting tray 1420. The supporting tray 1420 could be a rock grate for holding ceramic briquettes or lava rocks, as is often found in conventional gas grills.

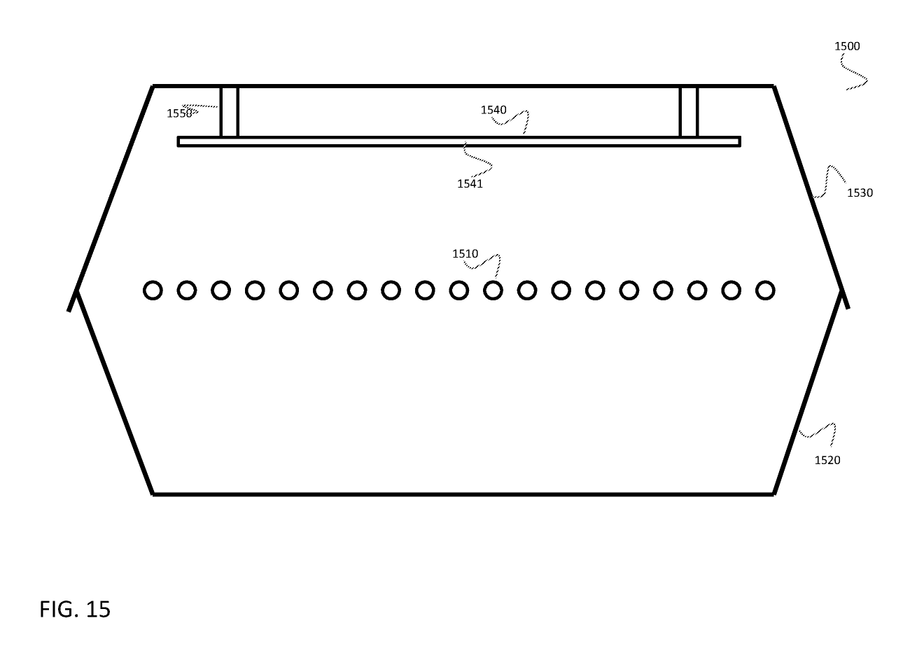

FIG. 15 is a cross-sectional illustration of a grill 1500 according to another embodiment of the invention. In this embodiment, the grill 1500 includes a cooking grate 1510, which can be any conventional grill cooking surface. The grate 1510 is positioned on and supported by a bottom grill housing 1520. A grill hood 1530 can be positioned over the bottom grill housing 1520 to provide an enclosed grill cavity. A heater panel 1540 is attached to the grill hood 1530 and suspended inside the grill cavity. A resistive heating layer 1541 is provided on the heater panel 1540. The use of a separate heater panel can be advantageous for ease of manufacture, to minimize capacitive leakage currents, and for ease of maintenance and replacement.

The heater panel 1540 can be composed of an insulating material, and the resistive heating layer 1541 can be deposited as a coating directly onto the panel 1540. The resistive film heating layer can be deposited using any of the methods described above in connection with FIGS. 4-14. The panel 1540 can comprise mica, which has good dielectric properties, and is relatively low cost. An insulating protective layer can optionally be provided over the resistive heating layer 1541. In one embodiment, the panel 1540 can comprise a pair of insulative substrates, such as mica substrates, that sandwich a resistive heating layer 1541 deposited on one of the substrates.

Where the panel 1540 is made of an electrically conductive material, such as a [symbol] metal, an insulating layer can be provided over the panel surface and the resistive heating layer 541 can be provided over the insulating layer.

A suspended panel 1540 can deliver intense radiant heat to food that is positioned [symbol] n the grate 1510. The suspended panel 1540 can be particularly advantageous for broiling. The [symbol] panel 1540 can be spaced from an interior wall of the hood 1530 by one or more spacers, such as posts 1550. One or more panels 1540 can be mounted to any interior wall of the hood 1530 or the bottom grill housing 1520, and spaced away from the wall using suitable spacers.

The heater panel 1540 can be the primary heat source for the grill 1500. In other embodiments, the grill 1500 can include other heat sources in addition to the heater panel 1540, such as the electric heat sources as described in connection with FIGS. 4-14, as well as conventional gas or charcoal heat sources.

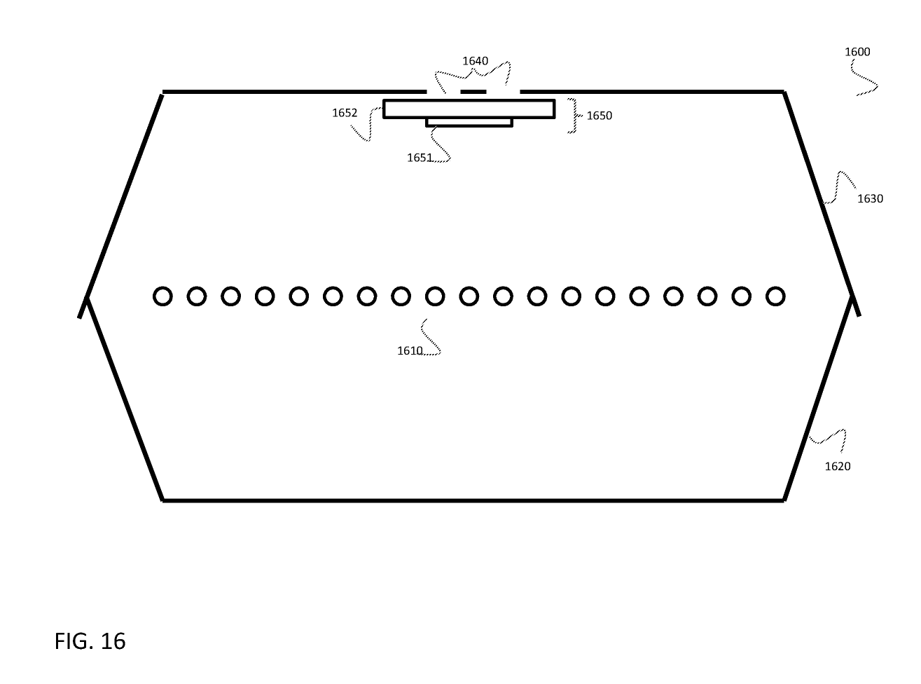

FIG. 16 is a cross-sectional illustration of a grill 1600 according to another embodiment of the invention. The grill 1600 in this embodiment includes a cooking grate 1610, a bottom grill housing 1620, and a grill hood 1630, similar to the grill 1500 of FIG. 15. The grill hood 1630 includes a smoke exhaust system 1640, which is typically one or more vent holes for venting smoke and fumes from the grill 1600, and an odor-removal device 1650 that is cooperatively associated with the exhaust system 1640. The odor-removal device 1650 is positioned so that most or all of the smoke generated by the grill 1600 passes through the odor-removal device 1650 for removal of contaminants before the treated smoke is exhausted to the environment through the exhaust system 1640.

It is well-known that barbeque grills produce undesirable smoke emissions, including undesirable contaminants such as vaporized grease droppings, that are malodorous, potentially dangerous, and have greatly inhibited the widespread use of barbeque grills indoors or in other enclosed spaces. Accordingly, the odor-removal device 1650 is provided to treat the smoke emissions from the grilling process, such as by catalytic conversion, in order to break down the complex organic contaminants into simpler molecules and thereby minimize the emission of foul odors from the grill 1600.

In one embodiment, the odor-removal device 1650 includes a catalyst material 1652 and a layered heater 1651 that is in thermal communication with the catalyst material 1652. The catalyst material 1652 acts upon the cooking emissions to break down complex organic molecules and reduce odors. The layered heater 1651 heats the catalyst material 1652 to a temperature sufficient to support a catalytic reaction.

In one embodiment, the catalyst material 1652 is a layered metallic substrate coated with a high surface area aluminum oxide coating that has been impregnated with analytically active elements. The substrate is processed to provide a plurality of channels through the substrate through which the smoke from the grill can flow. The catalytically active elements can be one or more elements from the platinum group metal series. The catalytically active elements act upon emissions from the cooking process to break them down into simpler forms. It will be understood that in addition to the layered metallic substrate, other substrate materials for supporting catalytically active elements can be used, such as a honeycomb structure, wire mesh, expanded metal, metal foam or ceramics. Also, other materials besides elements from the platinum group metal series, such as elements from Groups IVA to IIB of the periodic table, can be used as catalytically active elements. Exemplary embodiments of catalyst materials 1652 suitable for use in the present invention are described in U.S. Published Application No. 2009/0050129 to Robinson, Jr., the entire teachings of which are incorporated by reference herein.

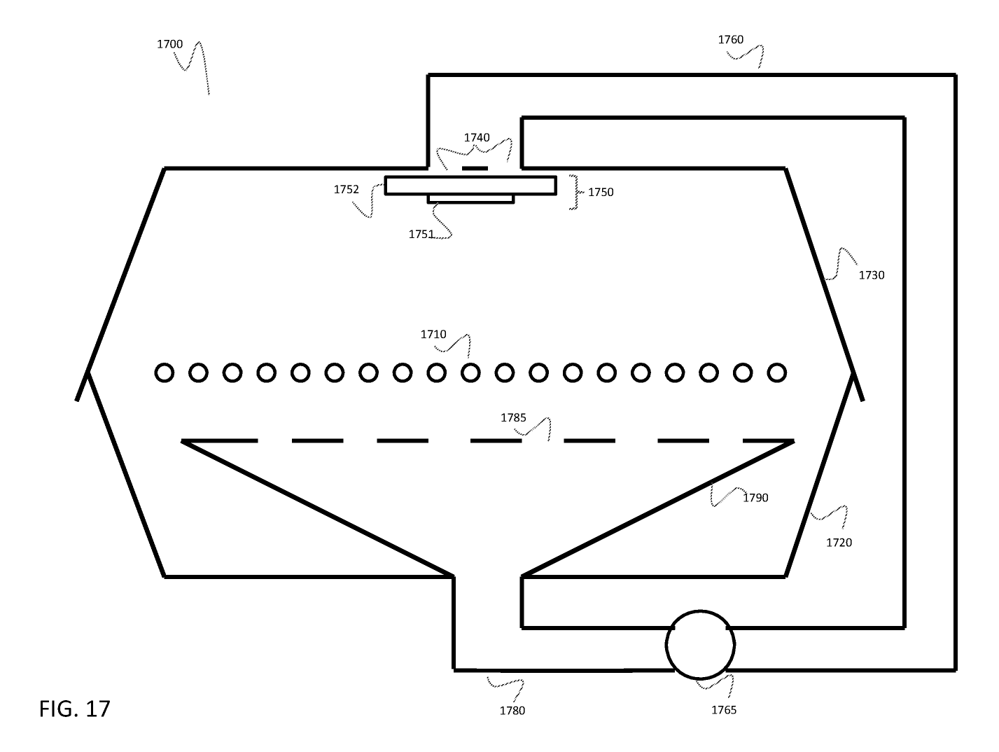

FIG. 17 is a cross-sectional illustration of a grill 1700 according to another embodiment of the invention. The grill 1700 in this embodiment includes a cooking grate 1710, a bottom grill housing 1720, and a grill hood 1730, similar to the grill 1500 of FIG. 15 and the grill 1600 of FIG. 16. The grill hood 1730 includes a smoke exhaust system 1740 similar to the smoke exhaust system 1540 of FIG. 15, which is typically one or more vent holes for venting smoke and fumes from the grill 1700, and an odor-removal device 1750 that is cooperatively associated with the exhaust system 1740. The odor-removal device 1750, similar to the odor-removal device 1550 of FIG. 15, is positioned so that most or all of the smoke generated by the grill 1700 passes through the odor-removal device 1750 for removal of contaminants before the cleaned smoke is exhausted to a pipe 1760 that is coupled to a blower 1765. The output of the blower 1765 is coupled to a second pipe 1780 that is coupled with the grill housing 1720 on the bottom, back or side. The second pipe 1780 carries the treated, heated smoke that is re-circulated in the grill 1700 to provide convection heat via a plenum 1790 with diffuser holes 1785.

Optionally the blower can be covered with a resistive heater surface to control the heat of the treated smoke re-circulated into the grill 1700.

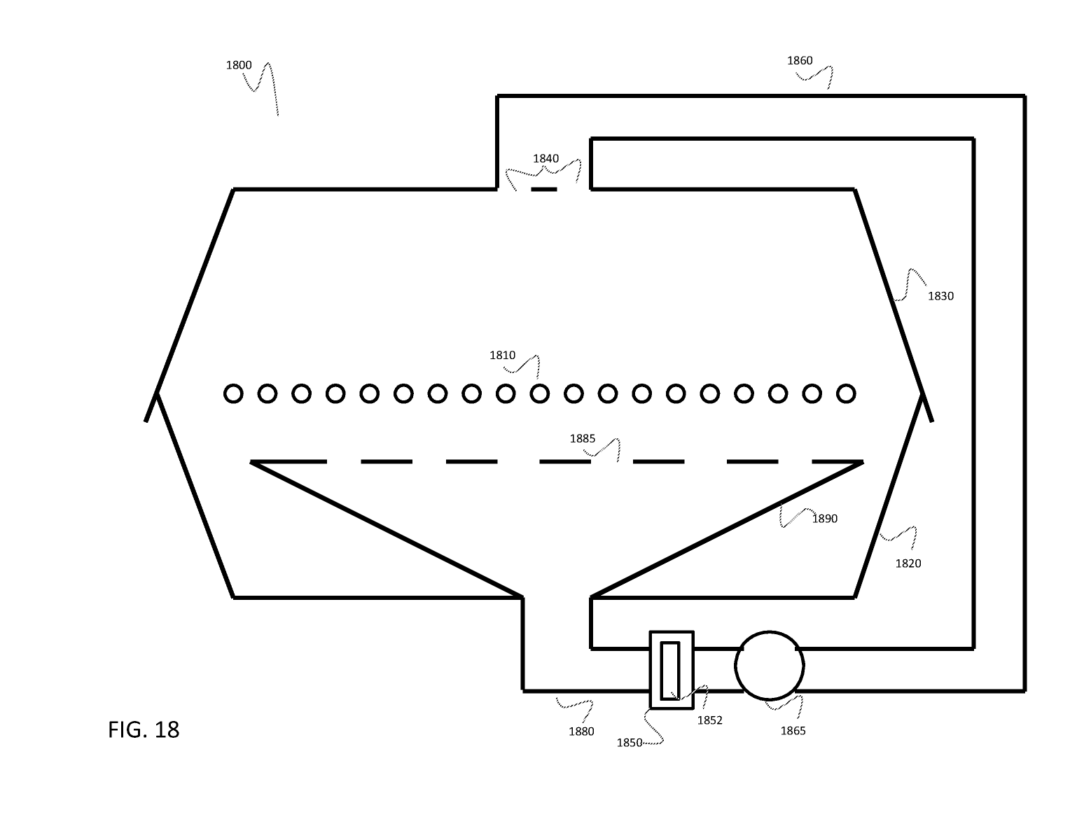

FIG. 18 is a cross-sectional illustration of a grill 1800 according to another embodiment of the invention. The grill 1800 in this embodiment includes a cooking grate 1810, bottom grill housing 1820, and a grill hood 1830, similar to the grill 1500 of FIG. 15 and the grill 1600 of FIG. 16. The grill hood 1830 includes a smoke exhaust system 1840 similar to the smoke exhaust system 1540 of FIG. 15, which is typically one or more vent holes for venting smoke and fumes from the grill 1800 into a re-circulating pipe 1860. The pipe 1860 is coupled to a blower 1865, which is in turn coupled to an odor-removal device 1850, similar to the odor-removal device 1550 of FIG. 15. The odor-removal device is positioned so that most or all of the smoke re-circulated by the blower 1865 passes through the odor-removal device 1850 for removal of contaminants before the treated smoke returned into the grill 1800 through a second pipe 1880 that is coupled with the grill housing 1820 on the bottom, back or side. The second pipe 1880 carries clean, heated air that is re-circulated by the blower 1865 in the grill 1800 to provide convection heat via a plenum 1890 with diffuser holes 1885. Optionally the blower can be covered with a resistive heater surface to control the heat of the treated smoke re-circulated into the grill 1800.

The layered heater 1651 is formed as a coating, and can comprise, for example, a deposited resistive heating layer using techniques discussed above in relation to FIG. 9. The layered heater 1651 can be provided in close proximity to the catalyst material 1652, and transfers heat to the catalyst material 1652 through conductive, radiative or convective heat transfer processes, or through a combination of these processes. For example, the layered heater 1651 can be deposited directly on the catalyst material 1652 or on a tray or other support upon which the catalyst material 1652 is supported for maximum conductive heat transfer. The layered heater 1651 can be spaced away from the catalyst material 1652, such as on a separate panel that faces the catalyst material 1652 and provides radiant heating to the catalyst material 1652. The heater layer 1651 can also be positioned within a duct or other gas conduit, upstream of the catalyst material 1652, and can heat the smoke emanating from the grill to a temperature sufficient to support catalytic reaction at the catalyst material 1652. In some embodiments, the heater layer 1651 can heat the smoke to a temperature sufficient to oxidize the carbon contaminants in the smoke without the use of an expensive precious metal catalyst material.

It will be understood that the odor-removal device 1650 can be advantageously utilized with any of the electric grill embodiments as described in connection with FIGS. 4-15, as well as with any conventional gas or charcoal grills.

In general, the heater layers in any of the embodiments of the present invention [symbol] in be designed with knowledge of the applied voltage and power desired. From these quantities, a necessary resistance is calculated. Knowing the resistance and the material sensitivity, the dimensions of the heater layers, or an element containing a heater layer, can then [symbol] be determined. Depending on the deposition technique, the material resistivity can be modified to optimize the design. It should be noted that the heater layers or elements containing a heater layer, may be shaped many different ways so as to provide heating in accordance with a required heating pattern.

There are many advantages to using a resistive heating layer provided as a coating in accordance with the present invention including, but not limited to: the heater coating occupying almost no space and having almost no mass, thereby allowing a compact design and adding to thermal efficiency since the heater coating does not require energy to heat up; the heater coating being typically well bonded to a part, or substrate, that it is deposited on, thereby maintaining very little impedance to the flow of heat to that part (i.e., increased thermal efficiency); the heater coating distributing power over an area it covers; the heater coating having the capability of distributing power non-uniformly over its surface to compensate for edge losses, thereby providing uniform temperature distributions over a grilling surface; and/or, the heater coating being amenable to common manufacturing methods where cost and volume are important.

Various applications for heaters and resistive heating layers of the invention, and methods for fabrication of heating elements, are described in commonly-owned U.S. Pat. Nos. 6,919,543, 6,924,468, 7,123,825, 7,176,420, 7,834,296, 7,919,730, 7,482,556, 8,306,408, 8,428,445 and in commonly-owned U.S. Published Patent Applications Nos. 2011/0180527 A1, 2011/0188838 A1, and 2012/0074127 A1. The entire teachings of the above-referenced patents and patent applications are incorporated herein by reference.

It should be emphasized that the above-described embodiments of the present invention are merely possible examples of implementations, merely set forth for a clear understanding of the principles of the invention. Many variations and modifications may be made to the above-described embodiments of the invention without departing substantially from the spirit and principles of the invention. All such modifications and variations are intended to be included herein within the scope of this disclosure and the present invention and protected by the following claims.

What is claimed is:

1. A heater comprising at least one thermally sprayed resistive heating layer, said resistive heating layer comprising:
a first metallic component that is electrically conductive and capable of reacting with a gas to form one or more carbide, oxide, nitride, and boride derivative;
one or more oxide, nitride, carbide, and boride derivative of the metallic component that is electrically insulating; and
a third component capable of stabilizing the resistivity of the resistive heating layer;
wherein said resistive heating layer has a resistivity of from about 0.0001 to about 1.0 Ωcm; and
wherein application of current from a power supply to said resistive heating layer results in production of heat by said resistive heating layer.

2. The heater of claim 1, wherein the resistivity of the resistive heating layer does not increase substantially during heating, or increases by about 0.003% per ° C. or less during heating.

3. The heater of claim 1 or 2, wherein said third component has a negative temperature coefficient of resistivity (NTC).

4. The heater of any one of claims 1 to 3, wherein the third component is capable of pinning the grain boundaries of the first metallic component deposited in the resistive heating layer, the third component being dispersed at the grain boundaries of the first metallic component in the resistive heating layer and inhibiting grain growth during heating.

5. The heater of any one of claims 1 to 4, wherein the first metallic component comprises aluminum (Al), carbon (C), cobalt (Co), chromium (Cr), hafnium (Hf), iron (Fe), magnesium (Mg), manganese (Mn), molybdenum (Mo), nickel (Ni), silicon (Si), tantalum (Ta), titanium (Ti), tungsten (W), vanadium (V), zirconium (Zr), or a mixture or alloy thereof.

6. The heater of claim 5, wherein the first metallic component comprises aluminum (Al).

7. The heater of claim 5 or 6, wherein said one or more oxide, nitride, carbide, and boride derivative comprises aluminum oxide.

8. The heater of any one of claims 1 to 7, wherein the third component comprises one or more of aluminum, barium, bismuth, boron, carbon, gallium, germanium, hafnium, magnesium, samarium, silicon, strontium, tellurium, and yttrium.

9. The heater of claim 8, wherein the third component comprises one or more boride, oxide, carbide, nitride, and carbo-nitride derivative of aluminum, barium, bismuth, boron, carbon, gallium, germanium, hafnium, magnesium, samarium, silicon, strontium, tellurium, or yttrium.

10. The heater of claim 8 or 9, where the third component comprises boron phosphide, barium titanate, hafnium carbide, silicon carbide, boron nitride, yttrium oxide, or a mixture or alloy thereof.

11. The heater of any one of claims 4 to 7, wherein the third component comprises one or more of boride, oxide, carbide, nitride, and carbo-nitride derivative of actinium (Ac), boron (B), carbon (C), hafnium (Hf), lanthanum (La), lutetium (Lu), molybdenum (Mo), niobium (Nb), palladium (Pd), rubidium (Rb), rhodium (Rh), ruthenium (Ru), scandium (Sc), strontium (Sr), tantalum (Ta), technetium (Tc), titanium (Ti), yttrium (Y), or zirconium (Zr); or a mixture or alloy thereof.

12. The heater of claim 11, wherein the third component comprises one or more boride, oxide, carbide, nitride, and carbo-nitride derivative of boron (B), carbon (C), strontium (Sr), titanium (Ti), yttrium (Y), or zirconium (Zr); or a mixture or alloy thereof.

13. The heater of claim 11 or 12, where the third component comprises hafnium diboride, strontium oxide, strontium nitride, tantalum diboride, titanium nitride, titanium dioxide, titanium(II) oxide, titanium(III) oxide, titanium diboride, yttrium oxide, yttrium nitride, yttrium diboride, yttrium carbide, zirconium diboride, or zirconium silicide; or a mixture or alloy thereof.

14. The heater of any one of claims 1 to 4, wherein the metallic component comprises aluminum (Al); the one or more oxide, nitride, carbide, and boride derivative comprises an aluminum oxide; and the third component is capable of altering the structure of the aluminum oxide grains deposited in the resistive heating layer.

15. The heater of claim 14, wherein the aluminum oxide grains are columnar in shape.

16. The heater of claim 14 or 15, wherein said altered structure of the aluminum oxide grains increases oxidation resistance or prevents oxidation of the first metallic component in the resistive heating layer.

17. The heater of any one of claims 14 to 16, wherein the aluminum oxide comprises Al₂O₃.

18. The heater of any one of claims 14 to 17, wherein the first metallic component further comprises carbon (C), cobalt (Co), chromium (Cr), hafnium (Hf), iron (Fe), magnesium (Mg), manganese (Mn), molybdenum (Mo), nickel (Ni), silicon (Si), tantalum (Ta), titanium (Ti), tungsten (W), vanadium (V), zirconium (Zr), or a mixture or alloy thereof.

19. The heater of any one of claims 14 to 18, wherein the third component comprises actinium (Ac), cerium (Ce), lanthanum (La), lutetium (Lu), scandium (Sc), unbiunium (Ubu), yttrium (Y), or a mixture or alloy thereof.

20. The heater of any one of claims 14 to 19, wherein the resistive heating layer further comprises one or more oxide, nitride, carbide, and boride derivative of the third component.

21. The heater of any one of claims 1 to 20, wherein the first metallic component comprises a mixture of chromium (Cr) and aluminum (Al).

22. The heater of claim 21, wherein the first metallic component further comprises cobalt (Co), iron (Fe), and/or nickel (Ni).

23. The heater of claim 22, wherein the first metallic component is a cobalt-based alloy or mixture.

24. The heater of claim 22, wherein the first metallic component is an iron-based alloy or mixture.

25. The heater of claim 22, wherein the first metallic component is a nickel-based alloy or mixture.

26. The heater of claim 21 or 22, wherein the first metallic component is CrAl, AlSi, NiCrAl, CoCrAl, FeCrAl, FeNiAl, FeNiCrAl, FeNiAlMo, NiCoCrAl, CoNiCrAl, NiCrAlCo, NiCoCrAlHfSi, NiCoCrAlTa, NiCrAlMo, NiMoAl, NiCrBSi, CoCrWSi, CoCrNiWTaC, CoCrNiWC, CoMoCrSi, or NiCrAlMoFe.

27. The heater of any one of claims 1 to 26, wherein said resistive heating layer has a resistivity of from about 0.0001 to about 0.001 Ω·cm.

28. The heater of claim 27, wherein said resistive heating layer has a resistivity of from about 0.001 to about 0.01.

29. The heater of claim 28, wherein said resistive heating layer has a resistivity of from about 0.0005 to about 0.0020.

30. The heater of any one of claims 1 to 29, wherein said resistive heating layer is from about 0.002 to about 0.040 inches thick.

31. The heater of any one of claims 1 to 30, wherein said resistive heating layer has an average grain size of from about 10 to about 400 microns.

32. The heater of any one of claims 1 to 31, wherein said resistive heating layer is formed on a substrate by thermal spraying of a feedstock comprising the first metallic component and the third component in the presence of a gas comprising one or more of oxygen, nitrogen, carbon, and boron, such that said one or more oxide, nitride, carbide, and boride derivative is formed during said thermal spraying of said feedstock onto said substrate to form said resistive heating layer.

33. The heater of any one of claims 1 to 13 and 21 to 31, wherein said resistive heating layer is formed on a substrate by thermal spraying of a feedstock comprising the first metallic component and an elemental form of the third component in the presence of a gas comprising one or more of oxygen, nitrogen, carbon, and boron, such that said one or more oxide, nitride, carbide, and boride derivative and said third component are formed during said thermal spraying of said feedstock onto said substrate to form said resistive heating layer.

34. The heater of claim 33, wherein said feedstock further comprises the third component.

35. The heater of claim 33 or 34, wherein said feedstock comprising said elemental form of the third component comprises CrAlY, CoCrAlY, NiCrAlY, NiCoCrAlY, CoNiCrAlY, NiCrAlCoY, FeCrAlY, FeNiAlY, FeNiCrAlY, NiMoAlY, NiCrAlMoY, or NiCrAlMoFeY.

36. The heater of any one of claims 33 to 35, wherein the resistive heating layer further comprises the elemental form of the third component.

37. The heater of any one of claims 1 to 36, wherein said resistive heating layer is electric arc wire sprayed, plasma sprayed, or high velocity oxy-fuel sprayed (HVOF).

38. The heater of any one of claims 32 to 37, wherein the feedstock is in the form of a wire.

39. The heater of any one of claims 32 to 37, wherein the feedstock is in the form of a powder.

40. The heater of any one of claims 33 to 37, wherein the first metallic component, the third component and/or the elemental form of the third component are combined together as a mixture or alloy before spraying.

41. The heater of any one of claims 1 to 31, further comprising a substrate on which said resistive heating layer is coated.

42. The heater of any one of claims 32 to 41, wherein said substrate comprises a conductor, a metal, a ceramic, a plastic, graphite, or a carbon fiber element.

43. The heater of any one of claims 32 to 42, wherein said substrate is a pipe, nozzle, impellor, or sparkless ignition device, or is employed in a rapid thermal processing apparatus.

44. The heater of any one of claims 1 to 43, further comprising a voltage source coupled to said resistive heating layer.

45. The heater of any one of claims 1 to 44, wherein said resistive heating layer comprises a plurality of thermally sprayed layers.

46. The heater of any one of claims 1 to 45, further comprising a thermal barrier layer.

47. The heater of claim 46, wherein the thermal barrier layer is disposed between said substrate and said resistive heating layer.

48. The heater of claim 46, wherein said resistive heating layer is disposed between said thermal barrier layer and said substrate.

49. The heater of any one of claims 32 to 48, further comprising one or more of: a bonding layer between said substrate and said resistive heating layer; an electrically insulating layer between said substrate and said resistive heating layer; and a thermal barrier layer between said substrate and said resistive heating layer.

50. The heater of any one of claims 1 to 49, further comprising a coating on said resistive heating layer, said coating comprising one or more of a thermal barrier layer, an electrically insulating layer, a thermally emissive layer, and a thermally conductive layer.

51. The heater of any one of claims 1 to 50, wherein said heater is operable up to 1400° C. in air.

52. A thermally sprayed resistive heating layer on a substrate, said resistive heating layer being formed by thermal spraying of a feedstock in the presence of a gas comprising one or more of oxygen, nitrogen, carbon, and boron, the feedstock comprising an alloy or mixture having the structure of formula I:
M₁X (I)
wherein:
M₁ is a first metallic component that is electrically conductive and capable of reacting with the gas to form one or more carbide, oxide, nitride, and boride derivative thereof;
said first metallic component reacts with said gas during said thermal spraying, forming one or more carbide, oxide, nitride, and boride derivative thereof; and
X is a third component and/or an elemental form thereof, said third component being capable of stabilizing the resistivity of the resistive heating layer.

53. The resistive heating layer of claim 52, wherein said third component is capable of pinning the grain boundaries of the first metallic component deposited in the resistive heating layer.

54. The resistive heating layer of claim 52 or 53, wherein X comprises said elemental form of the third component and not the third component itself, said elemental form reacting with said gas during said thermal spraying to form said third component.

55. The resistive heating layer of claim 54, wherein said elemental form reacts only partially with said gas, and both said third component and said elemental form thereof are deposited in the resistive heating layer.

56. The resistive heating layer of claim 52, wherein X comprises both the third component and said elemental form thereof.

57. The resistive heating layer of claim 56, wherein both said third component and said elemental form thereof are deposited in the resistive heating layer.

58. The resistive heating layer of any one of claims 52 to 57 wherein said third component as a negative temperature coefficient of resistance (NTC).

59. The resistive heating layer of any one of claims 52 to 58, wherein said third component [symbol] said elemental form thereof is dispersed at the grain boundaries of said first metallic component in the resistive heating layer and inhibits grain growth during heating.

60. The resistive heating layer of claim 52 or 53, wherein the feedstock comprises an alloy or mixture having the structure of formula Ia:
M₁Al X (Ia)
wherein:
M₁ is a first metallic component that is electrically conductive and capable of reacting with the gas to form one or more carbide, oxide, nitride, and boride derivative;
said first metallic component reacts with said gas during said thermal spraying, forming one or more carbide, oxide, nitride, and boride derivative;
Al reacts with said gas during said thermal spraying, forming one or more carbide, oxide, nitride, and boride derivative thereof; and
X is a third component capable of altering the grain structure of the one or more Al carbide, oxide, nitride, and boride derivative deposited in the resistive heating layer.

61. The resistive heating layer of claim 60, wherein said gas comprises oxygen, and said one or more Al carbide, oxide, nitride, and boride derivative comprises an aluminum oxide.

62. The resistive heating layer of claim 61, wherein said aluminum oxide comprises Al₂O₃.

63. The resistive heating layer of any one of claims 60 to 62, wherein X alters the grain structure of the aluminum oxide or the Al₂O₃ so that the aluminum oxide or Al₂O₃ grains are columnar in shape.

64. The resistive heating layer of claim 63, wherein the altered grain structure of the aluminium oxide or the Al₂O₃ increases oxidation resistance or prevents oxidation of M₁.

65. The resistive heating layer of any one of claims 60 to 64, wherein M₁ comprises carbon (C), cobalt (Co), chromium (Cr), hafnium (Hf), iron (Fe), magnesium (Mg), manganese (Mn), molybdenum (Mo), nickel (Ni), silicon (Si), tantalum (Ta), titanium (Ti), tungsten (W), vanadium (V), zirconium (Zr), or a mixture or alloy thereof.

66. The resistive heating layer of any one of claims 60 to 65, wherein X comprises actinium (Ac), cerium (Ce), lanthanum (La), lutetium (Lu), scandium (Sc), unbiunium (Ubu), yttrium (Y), [symbol] a mixture or alloy thereof.

67. The resistive heating layer of any one of claims 60 to 66, wherein M₁ comprises chromium (Cr), cobalt (Co), iron (Fe), and/or nickel (Ni).

68. The resistive heating layer of any one of claims 60 to 67, wherein the alloy or mixture of formula (I) comprises CrAlY, CoCrAlY, NiCrAlY, NiCoCrAlY, CoNiCrAlY, NiCrAlCoY, FeCrAlY, FeNiAlY, FeNiCrAlY, NiMoAlY, NiCrAlMoY, or NiCrAlMoFeY.

69. The resistive heating layer of any one of claims 60 to 68, wherein X reacts partially with said gas during said thermal spraying, forming one or more carbide, oxide, nitride, and boride derivative thereof.

70. The resistive heating layer of claim 69, wherein the resistive heating layer comprises X and one or more carbide, oxide, nitride, and boride derivative thereof.

71. The resistive heating layer of claim 70, wherein the resistive heating layer comprises X and an oxide derivative of X.

72. The resistive heating layer of any one of claims 52 to 71, wherein said third component stabilizes the resistivity of the resistive heating layer such that the resistivity of the resistive heating layer does not increase substantially during heating, or increases by about 0.003% per ° C. or less during heating.

73. The resistive heating layer of any one of claims 52 to 59 and 72, wherein M₁ comprises aluminum (Al), carbon (C), cobalt (Co), chromium (Cr), hafnium (Hf), iron (Fe), magnesium (Mg), manganese (Mn), molybdenum (Mo), nickel (Ni), silicon (Si), tantalum (Ta), titanium (Ti), tungsten (W), vanadium (V), zirconium (Zr), or a mixture or alloy thereof.

74. The resistive heating layer of claim 73, wherein M₁ comprises aluminum (Al).

75. The resistive heating layer of claim 74, wherein said one or more oxide, nitride, carbide, and boride derivative comprises aluminum oxide.

76. The resistive heating layer of any one of claims 52 to 59 and 72 to 75, wherein X comprises one or more of aluminum, barium, bismuth, boron, carbon, gallium, germanium, hafnium, magnesium, samarium, silicon, strontium, tellurium, and yttrium.

77. The resistive heating layer of any one of claims 52 to 59 and 72 to 75, wherein X comprises one or more boride, oxide, carbide, nitride, and carbo-nitride derivative of aluminum, barium, bismuth, boron, carbon, gallium, germanium, hafnium, magnesium, samarium, silicon, strontium, tellurium, or yttrium.

78. The resistive heating layer of any one of claims 52 to 59 and 72 to 75, wherein X comprises boron phosphide, barium titanate, hafnium carbide, silicon carbide, boron nitride, yttrium oxide, or a mixture or alloy thereof.

79. The resistive heating layer of any one of claims 52 to 59 and 72 to 75, wherein the third component comprises one or more of aluminum, barium, bismuth, boron, carbon, gallium, germanium, hafnium, magnesium, samarium, silicon, strontium, tellurium, and yttrium.

80. The resistive heating layer of any one of claims 52 to 59 and 72 to 75, wherein the third component comprises one or more boride, oxide, carbide, nitride, and carbo-nitride derivative of aluminum, barium, bismuth, boron, carbon, gallium, germanium, hafnium, magnesium, samarium, silicon, strontium, tellurium, or yttrium.

81. The resistive heating layer of any one of claims 52 to 59 and 72 to 75, wherein the third component comprises boron phosphide, barium titanate, hafnium carbide, silicon carbide, boron nitride, yttrium oxide, or a mixture or alloy thereof.

82. The resistive heating layer of any one of claims 52 to 59 and 72 to 75, wherein X comprises one or more boride, oxide, carbide, nitride, and carbo-nitride derivative of actinium (Ac), boron (B), carbon (C), hafnium (Hf), lanthanum (La), lutetium (Lu), molybdenum (Mo), niobium (Nb), palladium (Pd), rubidium (Rb), rhodium (Rh), ruthenium (Ru), scandium (Sc), strontium (Sr), tantalum (Ta), technetium (Tc), titanium (Ti), yttrium (Y), or zirconium (Zr); or a mixture or alloy thereof.

83. The resistive heating layer of any one of claims 52 to 59 and 72 to 75, wherein X comprises one or more boride, oxide, carbide, nitride, and carbo-nitride derivative of boron (B), carbon (C), strontium (Sr), titanium (Ti), yttrium (Y), or zirconium (Zr); or a mixture or alloy thereof.

84. The resistive heating layer of claim 82 or 83, where X comprises hafnium diboride, strontium oxide, strontium nitride, tantalum diboride, titanium nitride, titanium dioxide, titanium(II) oxide, titanium(III) oxide, titanium diboride, yttrium oxide, yttrium nitride, yttrium diboride, yttrium carbide, zirconium diboride, or zirconium silicide; or a mixture or alloy thereof.

85. The resistive heating layer of any one of claims 52 to 75, wherein X comprises actinium (Ac), boron (B), carbon (C), hafnium (Hf), lanthanum (La), lutetium (Lu), molybdenum (Mo), niobium (Nb), palladium (Pd), rubidium (Rb), rhodium (Rh), ruthenium (Ru), scandium (Sc), strontium (Sr), tantalum (Ta), technetium (Tc), titanium (Ti), yttrium (Y), or zirconium (Zr); or a mixture or alloy thereof.

86. The resistive heating layer of any one of claims 52 to 59 and 72 to 75, wherein X comprises boron (B), carbon (C), strontium (Sr), titanium (Ti), yttrium (Y), or zirconium (Zr); or a mixture or alloy thereof.

87. The resistive heating layer of any one of claims 52 to 59 and 72 to 75, wherein the third component comprises one or more of hafnium diboride, strontium oxide, strontium nitride, tantalum diboride, titanium nitride, titanium dioxide, titanium(II) oxide, titanium(III) oxide, titanium diboride, yttrium oxide, yttrium nitride, yttrium diboride, yttrium carbide, zirconium diboride, and zirconium silicide.

88. The resistive heating layer of any one of claims 52 to 59 and 72 to 75, wherein M₁ comprises a mixture of chromium (Cr) and aluminum (Al).

89. The resistive heating layer of claim 88, wherein M₁ further comprises cobalt (Co), iron (Fe), and/or nickel (Ni).

90. The resistive heating layer of claim 89, wherein M₁ is a cobalt-based alloy or mixture.

91. The resistive heating layer of claim 89, wherein M₁ is an iron-based alloy or mixture.

92. The resistive heating layer of claim 89, wherein M₁ is a nickel-based alloy or mixture.

93. The resistive heating layer of claim 88 or 89, wherein M₁ is CrAl, AlSi, NiCrAl, CoCrAl, FeCrAl, FeNiAl, FeNiCrAl, FeNiAlMo, NiCoCrAl, CoNiCrAl, NiCrAlCo, NiCoCrAlHfSi, NiCoCrAlTa, NiCrAlMo, NiMoAl, NiCrBSi, CoCrWSi, CoCrNiWTaC, CoCrNiWC, CoMoCrSi, or NiCrAlMoFe.

94. The resistive heating layer of any one of claims 52 to 59 and 72 to 93, wherein the alloy or mixture of formula (I) comprises CrAlY, CoCrAlY, NiCrAlY, NiCoCrAlY, CoNiCrAlY, NiCrAlCoY, FeCrAlY, FeNiAlY, FeNiCrAlY, NiMoAlY, NiCrAlMoY, or NiCrAMoFeY.

95. A heater comprising a thermally sprayed resistive heating layer according to any one of claims 52 to 94.

96. A method of producing a resistive heater having a substrate and a resistive heating layer, said method comprising the steps of:
a) selecting a first metallic component that is electrically conductive and capable of reacting with a gas to form one or more carbide, oxide, nitride, and boride derivative, said gas comprising one or more of nitrogen, oxygen, carbon, and boron;
b) selecting a third component and/or an elemental form thereof, said third component being capable of stabilizing the resistivity of the resistive heating layer; and
c) thermally spraying a mixture or alloy of the first metallic component and the third component and/or elemental form thereof in the presence of said gas onto the substrate, under conditions where: at least a portion of said first metallic component reacts with said gas to form said one or more carbide, oxide, nitride, and boride derivative; and said elemental form of said third component, if present, reacts at least partially with said gas to form said third component;
such that the resistive heating layer is deposited on the substrate, said resistive heating layer comprising the first metallic component, said one or more carbide, oxide, nitride, and boride derivative thereof, and said third component.

97. The method of claim 96, wherein said third component has a negative temperature coefficient of resistivity (NTC).

98. The method of claim 96 or 97, wherein said third component stabilizes the resistivity of the resistive heating layer such that the resistivity of the resistive heating layer does not increase substantially during heating, or increases by about 0.003% per ° C. or less during heating.

99. The method of any one of claims 96 to 98, wherein said third component is capable of pinning the grain boundaries of the first metallic component deposited in the resistive heating layer, said third component being dispersed at the grain boundaries of the first metallic component in the resistive heating layer and inhibiting grain growth of the first metallic component during heating.

100. The method of any one of claims 96 to 99, further comprising the steps of:
d) determining a desired resistivity of said resistive heating layer; and
e) selecting a proportion of said first metallic component and said gas, so that when sprayed said desired resistivity of said resistive heating layer results.

101. The method of any one of claims 96 to 100, further comprising the step of providing an electrically insulating layer between said substrate and said resistive heating layer.

102. The method of claim 101, further comprising the step of providing an adhesion layer between said insulating layer and said substrate.

103. The method of claim 102, wherein said adhesion layer comprises nickel-chrome alloy, nickel-chrome-aluminum-yttrium alloy, or nickel-aluminum alloy.

104. The method of any one of claims 96 to 103, further comprising the step of providing a heat reflective layer between said resistive heating layer and said substrate.

105. The method of claim 104, wherein said heat reflective layer comprises zirconium oxide.

106. The method of any one of claims 96 to 105, further comprising the step of providing a ceramic layer superficial to said resistive heating layer.

107. The method of claim 106, wherein said ceramic layer comprises aluminum oxide.

108. The method of any one of claims 96 to 107, further comprising the step of providing a metallic layer superficial to said resistive heating layer.

109. The method of claim 108, wherein said metallic layer comprises molybdenum or tungsten.

110. The method of any one of claims 96 to 109, wherein there is no reaction of said first metallic component with said gas prior to said step of thermal spraying.

111. The method of any one of claims 96 to 110, further comprising the step of providing power to said resistive heating layer.

112. The method of any one of claims 96 to 111, wherein said first metallic component comprises aluminum (Al), carbon (C), cobalt (Co), chromium (Cr), hafnium (Hf), iron (Fe), magnesium (Mg), manganese (Mn), molybdenum (Mo), nickel (Ni), silicon (Si), tantalum (Ta), titanium (Ti), tungsten (W), vanadium (V), zirconium (Zr), or a mixture or alloy thereof.

113. The method of claim 112, wherein the first metallic component comprises aluminum (Al).

114. The method of claim 113, wherein said one or more oxide, nitride, carbide, and boride derivative comprises aluminum oxide.

115. The method of claim 114, wherein said third component alters the structure of said aluminum oxide grains deposited in the resistive heating layer.

116. The method of claim 115, wherein said aluminum oxide grains deposited in said resistive heating layer are columnar in shape.

117. The method of claim 115 or 116, wherein said altered structure of the aluminum oxide grains increases oxidation resistance or prevents oxidation of the first metallic component deposited in said resistive heating layer.

118. The method of any one of claims 115 to 117, wherein the aluminum oxide comprises Al₂O₃.

119. The method of any one of claims 115 to 118, wherein said third component comprises actinium (Ac), cerium (Ce), lanthanum (La), lutetium (Lu), scandium (Sc), unbiunium (Ubu), yttrium (Y), or a mixture or alloy thereof.

120. The method of any one of claims 115 to 119, wherein the resistive heating layer further comprises one or more oxide, nitride, carbide, and boride derivative of the third component.

121. The method of any one of claims 115 to 120, wherein the first metallic component comprises a mixture of chromium (Cr) and aluminum (Al).

122. The method of claim 121, wherein the first metallic component further comprises cobalt (Co), iron (Fe), and/or nickel (Ni).

123. The method of any one of claims 115 to 122, wherein the first metallic component is a cobalt-based alloy or mixture.

124. The method of any one of claims 115 to 122, wherein the first metallic component is an iron-based alloy or mixture.

125. The method of any one of claims 115 to 122, wherein the first metallic component is a nickel-based alloy or mixture.

126. The method of any one of claims 115 to 125, wherein the first metallic component comprises aluminum and one or more additional metallic component selected from carbon (C), cobalt (Co), chromium (Cr), hafnium (Hf), iron (Fe), magnesium (Mg), manganese (Mn), molybdenum (Mo), nickel (Ni), silicon (Si), tantalum (Ta), titanium (Ti), tungsten (W), vanadium (V), zirconium (Zr), and a mixture thereof, said aluminum and said one or more additional metallic component provided together in the form of an alloy or mixture.

127. The method of claim 126, wherein the alloy or mixture is CrAl, AlSi, NiCrAl, CoCrAl, FeCrAl, FeNiAl, FeNiCrAl, FeNiAlMo, NiCoCrAl, CoNiCrAl, NiCrAlCo, NiCoCrAlHfSi, NiCoCrAlTa, NiCrAlMo, NiMoAl, or NiCrAlMoFe.

128. The method of any one of claims 96 to 114, wherein the third component comprises one or more of aluminum, barium, bismuth, boron, carbon, gallium, germanium, hafnium, magnesium, samarium, silicon, strontium, tellurium, and yttrium.

129. The method of any one of claims 96 to 114, wherein the third component comprises one or more boride, oxide, carbide, nitride, and carbo-nitride derivative of aluminum, barium, bismuth, boron, carbon, gallium, germanium, hafnium, magnesium, samarium, silicon, strontium, tellurium, or yttrium.

130. The method of any one of claims 96 to 114, wherein the third component comprises boron phosphide, barium titanate, hafnium carbide, silicon carbide, boron nitride, yttrium oxide, or a mixture or alloy thereof.

131. The method of any one of claims 96 to 114, wherein the third component comprises one or more boride, oxide, carbide, nitride, and carbo-nitride derivative of actinium (Ac), boron (B), carbon (C), hafnium (Hf), lanthanum (La), lutetium (Lu), molybdenum (Mo), niobium (Nb), palladium (Pd), rubidium (Rb), rhodium (Rh), ruthenium (Ru), scandium (Sc), strontium (Sr), tantalum (Ta), technetium (Tc), titanium (Ti), yttrium (Y), or zirconium (Zr); or a mixture or alloy thereof.

132. The method of claim 131, wherein the third component comprises one or more boride, oxide, carbide, nitride, and carbo-nitride derivative of boron (B), carbon (C), strontium (Sr), titanium (Ti), yttrium (Y), or zirconium (Zr); or a mixture or alloy thereof.

133. The method of claim 131 or 132, where the third component comprises hafnium diboride, strontium oxide, strontium nitride, tantalum diboride, titanium nitride, titanium dioxide, titanium(II) oxide, titanium(III) oxide, titanium diboride, yttrium oxide, yttrium nitride, yttrium diboride, yttrium carbide, zirconium diboride, or zirconium silicide; or a mixture or alloy thereof.

134. The method of any one of claims 96 to 114 and 128 to 133, wherein the first metallic component comprises a mixture of chromium (Cr) and aluminum (Al).

135. The method of claim 134, wherein the first metallic component further comprises cobalt (Co), iron (Fe), and/or nickel (Ni).

136. The heater of claim 135, wherein the first metallic component is a cobalt-based alloy or mixture.

137. The heater of claim 135, wherein the first metallic component is an iron-based alloy or mixture.

138. The heater of claim 135, wherein the first metallic component is a nickel-based alloy or mixture.

139. The method of any one of claims 96 to 114 and 128 to 138, wherein the first metallic component is CrAl, AlSi, NiCrAl, CoCrAl, FeCrAl, FeNiAl, FeNiCrAl, FeNiAlMo, NiCoCrAl, CoNiCrAl, NiCrAlCo, NiCoCrAlHfSi, NiCoCrAlTa, NiCrAlMo, NiMoAl, NiCrBSi, CoCrWSi, CoCrNiWTaC, CoCrNiWC, CoMoCrSi, or NiCrAlMoFe.

140. The method of any one of claims 96 to 114 and 128 to 139, wherein said mixture of the first metallic component and the third component and/or elemental form thereof comprises CrAlY, CoCrAlY, NiCrAlY, NiCoCrAlY, CoNiCrAlY, NiCrAlCoY, FeCrAlY, FeNiAlY, FeNiCrAlY, NiMoAlY, NiCrAlMoY, or NiCrAMoFeY.

141. The method of any one of claims 96 to 140, wherein said resistive heating layer has a resistivity of from about 0.0001 to about 0.001 Ω·cm.

142. The method of any one of claims 96 to 141, wherein said resistive heating layer is from about 0.002 to about 0.040 inches or from about from about 0.002 to about 0.020 inches thick.

143. The method of any one of claims 96 to 142, wherein said resistive heating layer has an average grain size of from about 10 to about 400 microns.

144. The method of any one of claims 96 to 143, wherein said mixture is a powder that is not pre-alloyed.

145. The method of any one of claims 96 to 143, wherein said alloy is a wire or a powder.

146. An electric grill comprising a heater according to any one of claims 1 to 51 and 95 or a thermally sprayed resistive heating layer according to any one of claims 52 to 94.

147. An electric grill comprising a grate; a heat shield positioned below the grate; and a resistive heating layer according to any one of claims 52 to 95 over a surface of the heat shield.

148. An electric grill comprising a metal sheet that is shaped to provide a structure for supporting food on the sheet and for draining liquid from the food; and an electrically resistive heating layer according to any one of claims 52 to 95 over a surface of the metal sheet.

149. A method of producing an electric grill having a grate that comprises a structure for supporting food on said grate and for draining liquid from said food, the method comprising: depositing a resistive heating layer according to any one of claims 52 to 95 on an electrical insulator to provide a heating element, the heating element being in thermal communication with the grate.

150. An electric grill comprising:
a grate;
an electrical insulator layer located on a bottom portion of said grate;
a thermally-sprayed resistive heating layer according to any one of claims 52 to 95 deposited on a bottom portion of said electrical insulator layer, on a portion opposite said grate; and
a heater plate located between said grate and said electric insulator layer, where said heater plate is capable of receiving energy radiated from the heating layer and transferring the received energy to the grate.

151. The electric grill of any one of claims 146 to 148 and 150, wherein said resistive heating layer is an electric resistive heater operating at 120 volts or 220 volts.

152. The electric grill of any one of claims 146 to 148 and 150 to 151, further comprising a power supply connected to said resistive heating layer.

153. The electric grill of any one of claims 146 to 148 and 150 to 152, wherein the grill heats primarily by radiant or convective heating or a combination thereof.
